(19) United States
(12) Patent Application Publication
(10) Pub. No.: US 2023/0330754 A1
(43) Pub. Date: Oct. 19, 2023

(54) METHOD AND APPARATUS FOR POSITIONING A PORTABLE DRILL

(71) Applicant: Woodpeckers, LLC, Strongsville, OH (US)

(72) Inventor: Benjamin T. Wollenburg, North Olmsted, OH (US)

(73) Assignee: Woodpeckers, LLC, Strongsville, OH (US)

(21) Appl. No.: 18/048,218

(22) Filed: Oct. 20, 2022

Related U.S. Application Data
(60) Provisional application No. 63/330,661, filed on Apr. 13, 2022.

(51) Int. Cl. B23B 45/00; B23B 47/28

(52) U.S. Cl. CPC B23B 45/003; B23B 47/28; B23B 49/003

(57) ABSTRACT

The present disclosure relates to a portable drill guide that is useable to enable a user to more accurately use a portable drill to drill a substantially vertical hole or angled hole into a workpiece in a controlled straight line. The portable drill guide includes a base plate; a pivot assembly selectively moveable with the base plate; at least one guide column operably engaged with the at least one guide column; and a chuck carrier operably engaged with the at least one guide column and being linearly moveable relative to the base plate. The chuck carrier and the at least one guide column of the portable drill guide are pivot with the pivot assembly relative to the base plate. Additional assemblies and components may be operably engaged with the portable drill guide for assisting in drilling substantially vertical hole or angled hole into a workpiece in a controlled straight line.

### REFERENCE TO RELATED APPLICATIONS

This application claims the benefit of U.S. Provisional Application Ser. No. 63/330,661, filed on Apr. 13, 2022; the disclosure of which is incorporated herein by reference.

### TECHNICAL FIELD

The present disclosure generally relates to a multipurpose tool for drilling substantially vertical holes or angled holes into a workpiece in a controlled straight line.

### BACKGROUND

Hand drills, handheld drills, and portable power drills are versatile tools which are used in multiple projects for drilling holes into different types of workpiece, such as wood workpiece. Generally, portable power drills are used in woodworking projects for drilling and/or boring holes of different dimensions based on the selected drilling bit used with a selected portable power the drill. While a woodworker may use a portable power drill to drill various types of holes in workpiece, it is difficult and demanding to drill precise and accurate holes into a workpiece where the holes are substantially straight and orthogonal to the longitudinal axis of the workpiece. More so, it is also difficult and demanding to drill precise and accurate holes into a workpiece where the holes are defined at various angles relative to the longitudinal axis of the workpiece that are not substantially straight and orthogonal to the longitudinal axis of the workpiece.

To address these difficulties and problems, a woodworker may select a device or multiple devices to help stabilize and guide his or her portable power drill during a drilling operation. While such assisting devices are provided in the market, the woodworker may have to use a number of different devices to drill different precise holes into a workpiece. For example, the woodworker may have to use a first set of assisting devices with the portable power drill for drilling a first hole with a first set of dimensions and a second set of assisting devices with the portable power drill for drilling a second hole with a second set of dimensions. In another example, the woodworker may have to use a first set of assisting devices with the portable power drill for drilling a first hole that is located in a center of a workpiece and a second set of assisting devices with the portable power drill for drilling a second hole at a location away from the center of a workpiece. Such use of multiple assisting devices requires the woodworker to have access to these various assisting devices and requires the expenditure of more time and effort when the woodworker is drilling multiple holes into a workpiece.

### SUMMARY

The presently disclosed drill guide provides a woodworker with a multifunctional tool which may be used for adjusting and aligning a portable drill in order to make a straight hole or an angled hole in a workpiece at a desired location and to a desired depth. The disclosed drill guide may reduce the overall number of portable drill assisting devices that a woodworker has to use to complete a project and may also the reduce the project's completion time since the need to switch between multiple devices is avoided. As such, the drill guide disclosed herein addresses some of the inadequacies of previously known drill assisting devices.

In one aspect, an exemplary embodiment of the present disclosure may provide a drill guide. The drill guide comprises a base plate; a pivot assembly selectively moveable with the base plate; at least one guide column operably engaged with the at least one guide column; and a chuck carrier operably engaged with the at least one guide column and being linearly moveable relative to the base plate; wherein the chuck carrier and the at least one guide column pivot are selectively pivotable with the pivot assembly relative to the base plate.

This exemplary embodiment or another exemplary embodiment may further include that the pivot assembly comprises at least one upright support operably engaged with the base plate; a pivot block operably engaged with the at least one upright support and the at least one guide column; and an adjustment assembly operably engaged with the at least one upright support and the pivot block; wherein the adjustment assembly is configured to selectively pivot the chuck carrier, the at least one guide column, and the pivot block relative to the base plate. This exemplary embodiment or another exemplary embodiment may further include that the adjustment assembly is configured to selectively pivot the chuck carrier, the at least one guide column, and the pivot block relative to the base plate in a released position when the adjustment assembly is free from engaging the at least one upright support. This exemplary embodiment or another exemplary embodiment may further include that the adjustment assembly is configured to maintain the chuck carrier, the at least one guide column, and the pivot block at a position relative to the base plate in an engaged position when the adjustment assembly is secured with the at least one upright support. This exemplary embodiment or another exemplary embodiment may further include that the pivot assembly further comprises: an upper slot defined in the at least one upright support; wherein the upper slot is configured to receive a portion of the adjustment assembly. This exemplary embodiment or another exemplary embodiment may further include that the pivot assembly further comprises: a lower slot defined in the at least one upright support; at least one bearing operably engaged with the at least one upright support inside of the lower slot and the pivot block; wherein the at least one bearing is configured to be slidably moveable inside of the lower slot of the at least one upright support.

In another aspect, an exemplary embodiment of the present disclosure may provide a method of guiding a portable drill for drilling at least one angled hole into a workpiece. The method comprises steps of: operably engaging the portable drill to chuck carrier of a drill guide; engaging at least one guide rod to a base plate of the drill guide; placing a base plate of the drill guide on the workpiece; titling the portable drill, the at least one guide rod, and the chuck carrier collectively, via a pivot assembly, to a desired angle relative to the base plate; guiding the portable drill for drilling the at least one angled hole into the workpiece.

This exemplary embodiment or another exemplary embodiment may further include steps of releasing an adjustment assembly of the pivot assembly from at least one upright support of the pivot assembly; and guiding the adjustment assembly, via an upper slot defined in the at least one upright support, along the at least one upright support. This exemplary embodiment or another exemplary embodiment may further include a step of guiding at least one bearing, via a lower slot defined in the at least one upright support, along the at least one upright support.

In yet one aspect, an exemplary embodiment of the present disclosure may provide a drill guide. Drill guide may include a base plate adapted to rest on a workpiece. Drill guide may also include a pivot assembly selectively moveable with the base plate. Drill guide may also include at least one guide column operably engaged with the pivot assembly. Drill guide may also include a chuck carrier operably engaged with the at least one guide column and being linearly moveable relative to the base plate, wherein the chuck carrier is adapted to engage with a portable drill and a drill bit. The chuck carrier, the at least one guide column, the drill bit, and the portable drill are selectively pivotable with the pivot assembly between a range of predetermined angles relative to the base plate. The pivot assembly is adapted to enable a longitudinal axis of the drill bit to be coaxial with a predetermined pivoting movement axis point scribed on the workpiece when the drill bit is pivoted at any angle defined in the range of predetermined angles.

This exemplary embodiment or another exemplary embodiment may further include a set of guide markers defined in the base plate enabling the base plate to be directly aligned with a set of witness marks on the workpiece defining the pivoting movement axis point; wherein the set of guide markers enables the longitudinal axis of the drill bit to be coaxial with the pivoting movement axis point on the workpiece when the drill bit is selectively pivoted between the range of predetermined angles relative to the base plate via the pivot assembly. This exemplary embodiment or another exemplary embodiment may further include a central opening defined in the base plate and extending entirely through the base plate; at least one pair of guide markers of the set of guide markers defined in the base plate interior of the central opening; and at least one another pair of guide markers of the set of guide markers defined in the base plate exterior to the central opening. This exemplary embodiment or another exemplary embodiment may further include that the pivot assembly comprises: at least one upright support operably engaged with the base plate; a pivot block operably engaged with the at least one upright support and the at least one guide column; and at least one adjustment assembly operably engaged with the pivot block; wherein the at least one adjustment assembly is configured to selectively pivot the chuck carrier, the at least one guide column, and the pivot block relative to the base plate. This exemplary embodiment or another exemplary embodiment may further include that when the at least one adjustment assembly is disengaged from the at least one upright support, the at least one adjustment assembly is configured to selectively pivot the chuck carrier, the at least one guide column, and the pivot block relative to the base plate. This exemplary embodiment or another exemplary embodiment may further include that when the at least one adjustment assembly is engaged with the at least one upright support, the at least one adjustment assembly is configured to maintain the chuck carrier, the at least one guide column, and the pivot block at a desired angle defined in the range of predetermined angles relative to the base plate. This exemplary embodiment or another exemplary embodiment may further include that the at least one adjustment assembly comprises: a threaded shaft operably engaged with the pivot block; and a handle operably engaged with the threaded shaft; wherein the handle is configured to be movable between an engaged position and a disengaged position with the at least one upright support for selectively pivoting the chuck carrier, the at least one guide column, and the pivot block relative to the base plate. This exemplary embodiment or another exemplary embodiment may further include that when the handle is disengaged from the at least one upright support, the at least one adjustment assembly is configured to selectively pivot the chuck carrier, the at least one guide column, and the pivot block relative to the base plate; and wherein when the handle is engaged with the at least one upright support, the at least one adjustment assembly is configured to maintain the chuck carrier, the at least one guide column, and the pivot block at a desired angle defined in the range of predetermined angles relative to the base plate. This exemplary embodiment or another exemplary embodiment may further include that the at least one adjustment assembly further comprises: a drag nut operably engaged with the threaded shaft and the at least one upright support and free from engaging the handle; wherein the drag nut is configured to engage the threaded shaft and the at least one upright support with one another. This exemplary embodiment or another exemplary embodiment may further include a calibration assembly operably engaged with the base plate and the pivot assembly; wherein the calibration assembly is configured to collectively calibrate the pivot assembly, the at least one guide column, and the chuck carrier to be orthogonal to the base plate. This exemplary embodiment or another exemplary embodiment may further include that the calibration assembly further comprises: a base member operably engaged with the base plate; and an adjustment member operably engaged with a pivot block of the pivot assembly and vertically moveable inside relative to the pivot block; wherein the adjustment member directly contacts with the base member to collectively calibrate the pivot assembly, the at least one guide column, and the chuck carrier to be orthogonal to the base plate. This exemplary embodiment or another exemplary embodiment may further include a first centering stop operably engageable with the base plate and the pivot block; and a second centering stop operably engageable with the base plate and the pivot block; wherein each of the first centering stop and the second centering stop is operably engaged with the base plate when provided in an operating position for aligning the drill bit in a center of the workpiece; wherein each of the first centering stop and the second centering stop is operably engaged with pivot block when provided in a stored position. This exemplary embodiment or another exemplary embodiment may further include a V-shaped groove defined in each of the first centering stop and the second centering stop; wherein the V-shaped groove defined in each of the first centering stop and the second centering stop enables the first centering stop and the second centering stop to engage with the workpiece and align the drill bit with an apex of the workpiece.

In another aspect, an exemplary embodiment of the present disclosure may provide a method of guiding a portable drill for drilling at least one angled hole into a workpiece. The method may comprise steps of: engaging the portable drill to chuck carrier of a drill guide; engaging a drill bit with a chuck of the chuck carrier; placing a base plate of the drill guide on the workpiece; pivoting the portable drill, the chuck carrier, and at least one guide column, collectively, via a pivot assembly, to a predetermined angle from a range of predetermined angles relative to the base plate, wherein a longitudinal axis of the drill bit is coaxial with a pivoting movement axis point scribed on the workpiece when the drill bit is selectively pivoted between the range of predetermined angles relative to the base plate; and guiding the portable drill for drilling the at least one angled hole into the workpiece.

This exemplary embodiment or another exemplary embodiment may comprise steps of aligning at least one pair of guide markers defined in the base plate with at least one witness line scribed on the workpiece; and aligning at least another pair of guide markers defined in the base plate with at least another witness line scribed on the workpiece; wherein the at least one pair of guide markers are positioned interior to a central opening defined in the base plate; and wherein the at least another pair of guide markers are positioned exterior to the central opening defined in the base plate. This exemplary embodiment or another exemplary embodiment may comprise steps of releasing an adjustment assembly of the pivot assembly from at least one upright support of the pivot assembly; and guiding the adjustment assembly, via an upper slot defined in the at least one upright support, along the at least one upright support. This exemplary embodiment or another exemplary embodiment may comprise a step of guiding at least one bearing, via a lower slot defined in the at least one upright support, along the at least one upright support. This exemplary embodiment or another exemplary embodiment may comprise a step of calibrating the chuck carrier, the at least one guide column, and the pivot assembly, via a calibration assembly, relative to the base plate until the chuck carrier, the at least one guide column, and the pivot assembly are orthogonal to the base plate. This exemplary embodiment or another exemplary embodiment may comprise steps of engaging a first centering button with the base plate; engaging a second centering button with the base plate; engaging the workpiece between the first centering button and the second centering button; and aligning the drill bit in a center of the workpiece via the first centering button and the second centering button; wherein the first centering button and the second centering button are provided in an operating position when engaged with the base plate. This exemplary embodiment or another exemplary embodiment may comprise steps of engaging a first centering button with the base plate; engaging a second centering button with the base plate; engaging the workpiece with the first centering button and the second centering button inside a V-shaped grooved defined in each first centering button and the second centering button, wherein the workpiece is rounded; and aligning the drill bit with an apex of said round workpiece via the first centering button and the second centering button; wherein the first centering button and the second centering button are provided in an operating position when engaged with the base plate. This exemplary embodiment or another exemplary embodiment may comprise steps of engaging a first centering button with a pivot block of the pivot assembly; and engaging a second centering button with the pivot block of the pivot assembly; wherein the first centering button and the second centering button are provided in a stored position when engaged with the pivot block.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 (FIG. 1) is a top, front, right side isometric perspective view of a drill guide in accordance with an aspect of the present disclosure.

FIG. 1A (FIG. 1A) is an enlargement view of the highlighted region in FIG. 1, wherein a first locking knob and a second locking knob are provided in an isolated exploded view from the drill guide.

FIG. 2 (FIG. 2) is a partial sectional view of the drill guide taken in the direction of line 2-2 in FIG. 1A.

FIG. 3 (FIG. 3) is a front elevation view of the drill guide in FIG. 1, wherein a drill chuck key of the drill guide is operably disengaged from a first upright support of a pivot assembly of the drill guide.

FIG. 4 (FIG. 4) is a rear elevation view of the drill guide in FIG. 1, wherein the drill chuck key of the drill guide is operably engaged with the first upright support of the drill guide.

FIG. 5 (FIG. 5) is a right side elevation view of the drill guide in FIG. 1.

FIG. 6 (FIG. 6) is a left side elevation view of the drill guide in FIG. 1.

FIG. 7 (FIG. 7) is a top sectional plan view of the drill guide taken in the direction of line 7-7 in FIG. 3.

FIG. 8 (FIG. 8) is a bottom plan view of the drill guide of FIG. 1.

FIG. 9 (FIG. 9) is a partial sectional view of the drill guide taken in the direction of line 9-9 in FIG. 7.

FIG. 10 (FIG. 10) is a top, front, right side isometric perspective view of a fence of a fence assembly, wherein at least one thumb screw of the fence assembly is exploded away from the fence.

FIG. 11 (FIG. 11) is a partial sectional view of the fence of the fence assembly taken in direction of line 11-11 in FIG. 10.

FIG. 12 (FIG. 12) is a top, front, right side isometric perspective view of at least one fence rod of the fence assembly.

FIG. 13 (FIG. 13) is a top, front, right side isometric perspective view of at least one button stop assembly, wherein a connector and a button stop of the at least one button stop assembly are exploded away from one another.

FIG. 14 (FIG. 14) is an operational view of the drill guide operably engaged with the fence assembly, wherein the drill guide and the fence assembly are introduced to a workpiece.

FIG. 15 (FIG. 15) is another operational view of the drill guide similar to FIG. 14, but the drill guide is pivoted to a desired angle via the pivot assembly of the drill guide and a depth stopper is selected along a first guide column of the drill guide.

FIG. 16 (FIG. 16) is another operational view of the drill guide similar to FIG. 15, but the drill guide operably engages with a portable drill and moves a drilling bit into the workpiece for drilling a hole.

FIG. 17A (FIG. 17A) is an operational view of the drill guide, wherein first and second button stop assemblies are operably engaged with the base plate of the drill guide.

FIG. 17B (FIG. 17B) is another operational view of the drill guide similar to FIG. 17A, but the first and second button stop assemblies operably engage with a workpiece in a first configuration.

FIG. 18 (FIG. 18) is an operational view of the drill guide similar to FIG. 17B, but the first and second button stop assemblies operably engage with the workpiece in a second configuration.

FIG. 19 (FIG. 19) is a top, front, right side isometric perspective view of another drill guide in accordance with another aspect of the present disclosure.

FIG. 20 (FIG. 20) is a rear elevation view of the drill guide shown in FIG. 19.

FIG. 21 (FIG. 21) is a right side elevation view of the drill guide shown in FIG. 19.

FIG. 22 (FIG. 22) is a sectional view of the drill guide shown in FIG. 19 taken in direction of line 20-20 shown in FIG. 20.

FIG. 23 (FIG. 23) is an operational view of a calibration assembly of the drill guide, wherein FIG. 23 is a sectional view of the drill guide taken in direction of line 23-23 shown in FIG. 22.

FIG. 24 (FIG. 24) is an operational view of button stops of the drill guide moving between operating positions and stored positions, wherein FIG. 24 is a sectional view of the drill guide taken in direction of line 24-24 shown in FIG. 22.

FIG. 25 (FIG. 25) is an operational view of adjustment assembly of the drill guide, wherein FIG. 25 is a sectional view of the drill guide taken in direction of line 25-25 shown in FIG. 22.

FIG. 26 (FIG. 26) is a top, front, right side isometric perspective view of a fence and thumb screws of another fence assembly.

FIG. 27 (FIG. 27) is an exemplary method flowchart of guiding a portable drill for drilling at least one angled hole into a workpiece.

FIG. 28 (FIG. 28) is another exemplary method flowchart of guiding a portable drill for drilling at least one angled hole into a workpiece.

Similar numbers refer to similar parts throughout the drawings.

### DETAILED DESCRIPTION

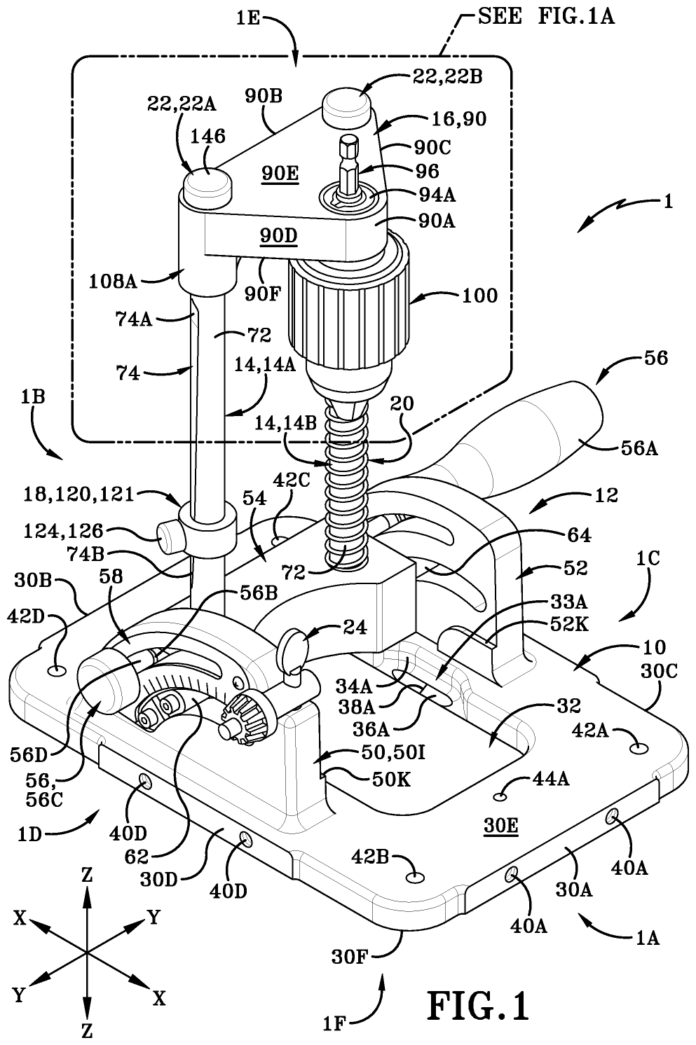

FIG. 1 illustrates a drill guide, shown generally at 1, for use with a hand drill or a portable drill, which is described in more detail below. Drill guide 1 generally includes a front end 1A, a rear end 1B that opposes the front end 1A, and a longitudinal axis “X” that extends between the front end 1A and the rear end 1B. Drill guide 1 also generally includes a left side or first side 1C, a right side or second side 1D that opposes the left side 1C, and a transverse axis “Y” that extends between the left side 1C and the right side 1D. Drill guide 1 generally includes a top end 1E, a bottom end 1F that opposes the top end 1E, and a vertical axis “Z” that extends between the top end 1E and the bottom end 1F. It should be understood that the terms “front,” “rear,” “left,” “right,” “top,” and “bottom” are used to describe the orientation of drill guide 1 illustrated in the attached figures and should in no way be considered to limit the orientation in which drill guide 1 may be utilized during a drilling operation.

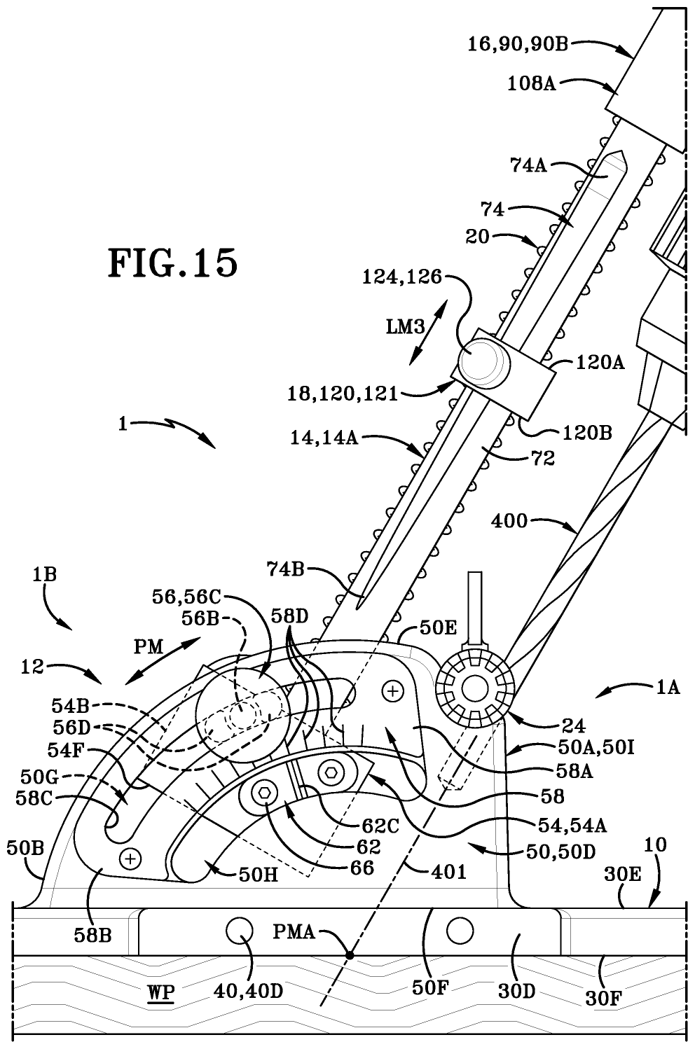

Referring now to FIG. 1, the drill guide 1 includes a base plate 10, a pivot assembly 12, at least one guide column 14, a chuck carrier 16, a depth stopper 18, a biaser 20, at least one locking knob 22, and a drill chuck key 24. Referring to FIG. 14, a fence assembly or first assembly 200 may be operably engaged the drill guide 1 as desired by a woodworker when using the drill guide 1 during a drilling operation. Such use of the fence assembly 200 is described in more detail later herein. These various components of the drill guide 1 and the fence assembly 200 will now each be described in greater detail.

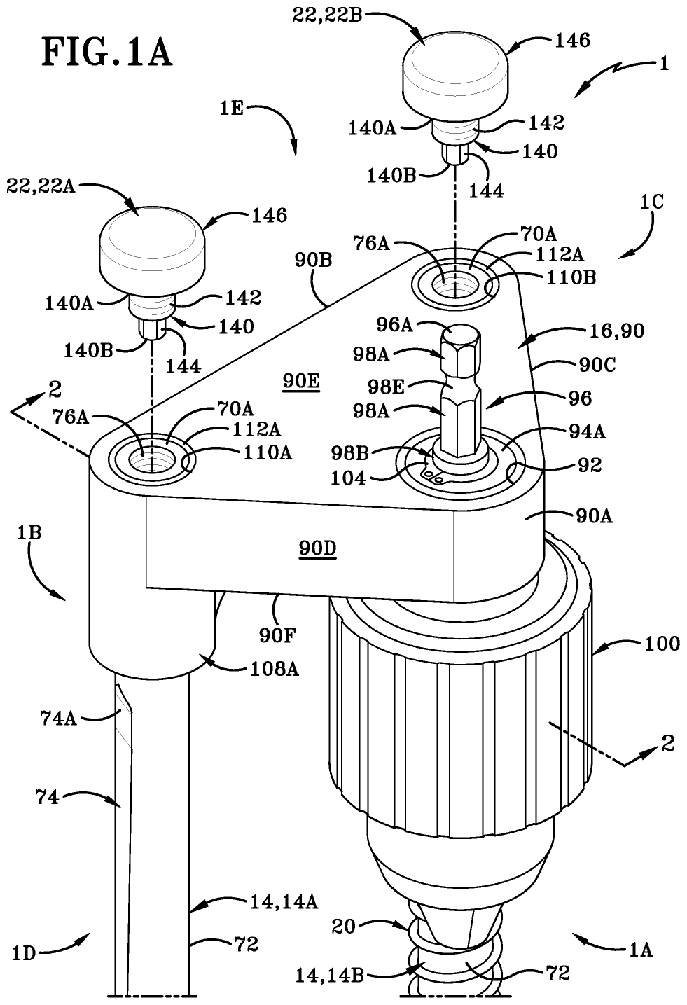

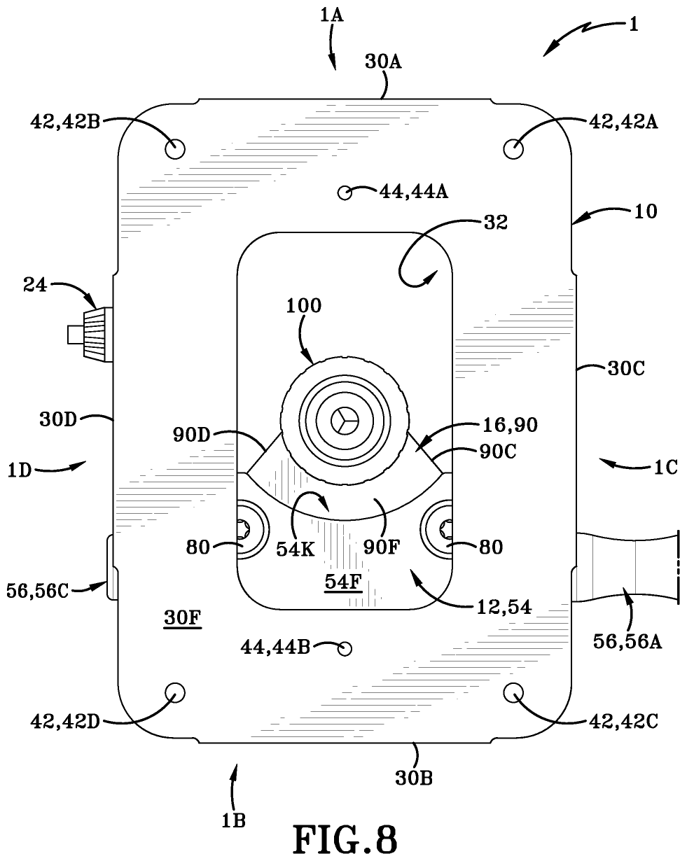

Referring now to FIGS. 1 and 2, the base plate 10 includes a front end 30A, a rear end 30B that opposes the front end 30A, and a longitudinal axis between the front end 30A and the rear end 30B. The longitudinal axis of base plate 10 is aligned with the longitudinal axis “X” of drill guide 1. The base plate 10 also includes a left side or first side 30C, a right side or second side 30D that opposes the left side 30C, and a transverse axis between the left side 30C to the right side 30D. The transverse axis of base plate 10 is aligned with the transverse axis “Y” of drill guide 1. The base plate 10 also includes a top surface 30E that faces the top end 1E of the drill guide 1 and extends from the front end 30A to the rear end 30B of the base plate 10. The base plate 10 also includes a bottom surface 30F (seen in FIG. 9) that faces the bottom end 1F of the drill guide 1 and extends from the front end 30A to the rear end 30B of the base plate 10. The vertical axis of base plate 10 extends between the top surface 30E and bottom surface 30F of the base plate 10 and is aligned with the vertical axis “Z” of drill guide 1.

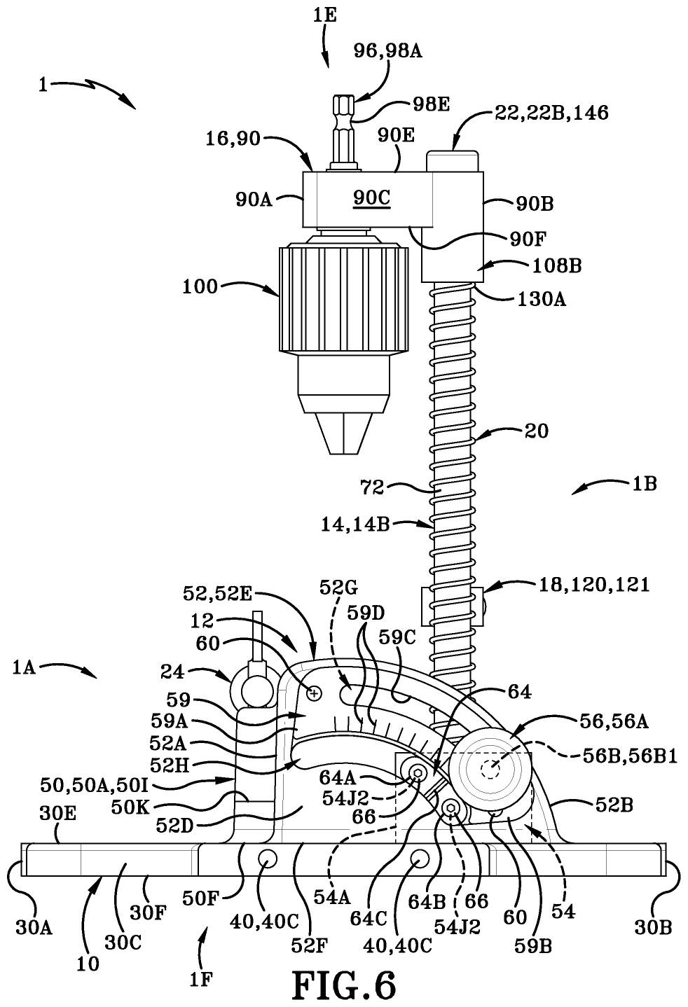

Still referring to FIGS. 1 and 7, the base plate 10 defines a central opening 32 that is disposed between the front end 30A and the rear end 30B of the base plate 10 and extends between top surface 30E and bottom surface 30F of base plate 10. In the illustrated embodiment, the central opening 32 defined by the base plate 10 is curvilinear and/or round in shape. In one exemplary embodiment, a central opening defined by a base plate may be substantially elongated such that the central opening defined by the base plate is oblong-shaped. In another exemplary embodiment, a central opening defined by a base plate may be substantially elongated such that the central opening defined by the base plate is ovoidal. Furthermore, the central opening 32 may be any suitable shape that will enable different types of drilling bits of different diameters and lengths to be received therethrough, in particular drilling bits up to diameters of one inch.

Still referring to FIGS. 1 and 7, the base plate 10 also defines first and second recesses 33A, 33B. Each of the first and second recesses 33A, 33B is bounded by a circumferential wall 34A, 34B extending from the top surface 30E to an angled bottom wall 36A, 36B disposed between the top surface 30E and the bottom surface 30F. As illustrated in FIGS. 1 and 7, first and second guide markers 38A, 38B are provided on the angled bottom walls 36A, 36B in which first and second guide marker 38A, 38B are aligned with one another parallel with the transverse axis of the base plate 10. The first and second guide markers 38A, 38B on the base plate 10 allows a woodworker to align the first and second guide markers 38A, 38B of the drill guide 1 with a set of witness lines provided on a workpiece for accurately positioning the drill guide 1 with a predetermined drilling location. Such use of first and second guide markers 38A, 38B of the drill guide 1 during a drilling operation is provided in more detail below.

Referring to FIG. 7, base plate 10 may also include a third guide marker 38C and a fourth guide marker (not illustrated herein) that are aligned with one another along an axis that is parallel with the longitudinal axis of the base plate 10. Similar to the first and second guide markers 38A, 38B, the third guide marker 38C and the fourth guide marker 38D on the base plate 10 allows a woodworker to align the third guide marker 38C and the fourth guide marker 38D of the drill guide 1 with a set of witness lines provided on a workpiece for accurately positioning the drill guide 1 with a predetermined drilling location. Such use of third guide marker 38C and the fourth guide marker 38D of the drill guide 1 during a drilling operation is provided in more detail below.

Referring now to FIGS. 1 and 3-6, the base plate 10 defines a set of threaded openings 40 that extends laterally into the base plate 10 relative to the longitudinal axis or the transverse axis of the base plate 10. Each threaded opening of the set of threaded openings 40 is substantially smaller than the central opening 32. In the illustrated embodiment, each of the front end 30A, rear end 30B, left side 30C, and right side 30D defines at least one threaded opening 40. In other words, the front end 30A of base plate 10 defines at least one threaded opening 40A from the set of threaded openings 40, the rear end 30B of base plate 10 defines at least one threaded opening 40B from the set of threaded openings 40, the left side 30C of base plate 10 defines at least one threaded opening 40C from the set of threaded openings 40, and the right side 30D of base plate 10 defines at least one threaded opening 40D from the set of threaded openings 40. In one exemplary embodiment, a front end, a rear end, a left side, and a right side of a base plate may define a pair of threaded openings in a set of threaded openings. In another exemplary embodiment, a front end, a rear end, a left side, and a right side of a base plate may define at least two threaded openings in a set of threaded openings. Such use of the set of threaded openings 40 is described in more detail below.

Referring now to FIG. 1, the base plate 10 defines a set of vertical passageways 42. Each vertical passageway of the set of vertical passageways 42 is substantially smaller than the central opening 32. Each vertical passageway of the vertical passageways 42 also extends entirely through the base plate 10 from the top surface 30E to the bottom surface 30F relative to the vertical axis “Z.” A first vertical passageway 42A of the set of vertical passageways 42 is defined proximate to the front end 30A and the left side 30C of the base plate 10. A second vertical passageway 42B of the set of vertical passageways 42 is defined proximate to the front end 30A and the right side 30D of the base plate 10. A third vertical passageway 42C of the set of vertical passageways 42 is defined proximate to the rear end 30B and the left side 30C of the base plate 10. A fourth vertical passageway 42D of the set of vertical passageways 42 is defined proximate to the rear end 30B and the right side 30D of the base plate 10. The set of vertical passageways 42A, 42B, 42C, 42D may be used for various woodworking projects. In one instance, the set of vertical passageways 42A, 42B, 42C, 42D may enable a woodworker to introduce connectors (e.g., fasteners and other connectors of the like) to the operably engage the base plate 10 with a support structure or a workpiece to fix the drill guide 1 at a desired position on the support structure or workpiece.

Referring now to FIG. 1, the base plate 10 defines a set of threaded vertical passageways 44. The set of threaded vertical passageways 44 includes a first vertical passageway 44A that is defined proximate to the front end 30A and between the left and right sides 30C, 30D of the base plate 10. The set of threaded vertical passageways 44 also includes a second vertical passageway 44B that is defined proximate to the rear end 30B and between the left and right sides 30C, 30D of the base plate 10. In the illustrated embodiment, the first threaded vertical passageway 44A and the second threaded vertical passageway 44B oppose one another on the base plate 10 and are configured to receive connectors for components and parts of the drill guide for specific woodworking projects, which is described in more detail below.

The drill guide 1 also includes a pivot assembly 12 that operably engages with the base plate 10. As described in more detail below, portions of the pivot assembly 12 are selectively moveable relative to the base plate 10 during woodworking projects. As such, the components of the pivot assembly 12 will now be described in more detail below.

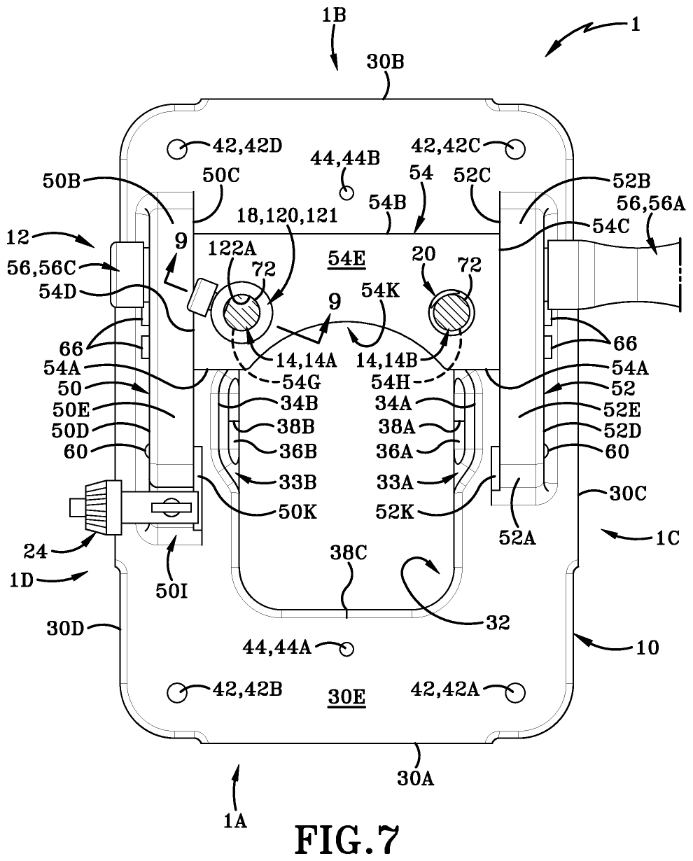

Referring to FIGS. 1 and 3-8, the pivot assembly 12 includes at least one upright support that operably engages with the base plate 10. In the illustrated embodiment, the pivot assembly 12 includes a first upright support 50 that operably engages with the top surface 30E of the base plate 10 and is positioned proximate to the right side 30D of the base plate 10, and a second upright support 52 that operably engages with the top surface 30E of the base plate 10 and is positioned proximate to the left side 30C of the base plate 10. In the illustrated embodiment, the first upright support 50 and the second upright support 52 are substantially similar to one another and operably engaged with the base plate 10 in a mirror-image orientation. Inasmuch as the first and second upright supports 50, 52 are substantially similar, the following description relates to the first upright support 50. It should be understood, however, that the description of the first upright support 50 applies equally to the second upright support 52.

Referring to FIG. 1, the first upright support includes a front end 50A, a rear end 50B that is opposite to the front end 50A, an inner surface 50C extending between the front and rear end 50A, 50B, and an outer surface 50D extending between the front and rear end 50A, 50B and opposite to the outer surface 50D. Additionally, the first upright support 50 includes a top end 50E positioned away from the top surface 30E of the base plate 10, and a bottom end 50F opposite to the top end 50E and operably engaged with the top surface 30E of the base plate 10.

Referring to FIGS. 1 and 5-6, the first upright support 50 defines a first or upper slot 50G. The upper slot 50G of the first upright support 50 has an arcuate and/or curvilinear shape that extends between the front end 50A and the rear end 50B. The upper slot 50G of the first upright support 50 also extends entirely through the first upright support 50 in which the inner and outer surfaces 50C, 50D of the first upright support 50 are in fluid communications with one another at the upper slot 50G. Such use and purpose of the upper slot 50G defined in the first upright support 50 is described in more detail below.

Still referring to FIGS. 1 and 5-6, the first upright support 50 also defines a second or lower slot 50H that is defined directly vertically below the upper slot 50G of the first upright support 50. The lower slot 50H of the first upright support 50 also has an arcuate and/or curvilinear shape that extends between the front end 50A and the rear end 50B. In the illustrated embodiment, the upper and lower slots 50G, 50H of the first upright support 50 match and/or is complementary in shape with one another. The lower slot 50H of the first upright support 50 also extends entirely through the first upright support 50 in which the inner and outer surfaces 50C, 50D of the first upright support 50 are in fluid communications with one another at the lower slot 50H. Such use and purpose of the lower slot 50H defined in the first upright support 50 is described in more detail below.

As described above, the second upright support 52 is substantially similar to the first upright support 51. As such, a front end 52A, a rear end 52B, an inner surface 52C, an outer surface 52D, a top end 52E, a bottom end 52F, a first or upper slot 52G, and a second or lower slot 52H are substantially similar to the front end 50A, rear end 50B, inner surface 50C, outer surface 50D, top end 50E, bottom end 50F, first or upper slot 50G, and second or lower slot 50H of the first upright support 50.

Referring to FIGS. 1, 3, and 4, at least upright support has a shoulder that extends outwardly away from the front end 50A of the at least upright support 50. In the illustrated drill guide 1, the first upright support 50 has a shoulder 501 that extends outwardly away from the front end 50A of the first upright support 50. The first upright support 50 also defines a cavity 50J that extends downwardly into the shoulder 501 towards the base plate 10. Such use and purpose of the shoulder 501 and cavity 50J are described in more detail below. In one exemplary embodiment, a second upright support may include a shoulder and a threaded cavity defined in the shoulder. In another exemplary embodiment, a first upright support and a second upright support may each include a shoulder and a threaded cavity defined in the respective shoulder.

Referring to FIGS. 1, 3, and 7, the first upright support 50 includes a protrusion 50K that extends laterally away from the inner surface 50C of the first upright support 50 towards the second upright support 52. Similarly, the second upright support 52 also includes a protrusion 52K that extends laterally away from the inner surface 50C of the first upright support 50 towards the second upright support 52. During woodworking projects, the protrusions 50K, 52K of the first and second upright supports 50, 52 may limit the rotational and/or pivoting movement of associated parts and components provided in the pivot assembly 12, which is described in more detail below.

Referring to FIGS. 1 and 3-8, the pivot assembly 12 includes a pivot block 54 that operably engages with first and second upright supports 50, 52 via an adjustment assembly 56, which is described in more detail below. The pivot block 54 is also positioned between the first upright support 50 and the second upright support 52 and vertically above the base plate 10. The pivot block 54 has a front end 54A, a rear end 54B opposite to the front end 54A, a first or left side 54C, a second or right side 54D opposite to the left side 54C, a top surface 54E, and a bottom surface 54F opposite to the top surface 54E.

Still referring to FIGS. 1 and 7, the pivot block 54 also defines at least vertical passageway that extends entirely through the pivot block 54 between the top surface 54E and the bottom surface 54F along an axis that is parallel with the vertical axis “Z”. In the illustrated pivot block 54, the pivot block 54 defines a first vertical passageway 54G that extends entirely through the pivot block 54 between the top surface 54E and the bottom surface 54F along an axis that is parallel with the vertical axis “Z”. Similarly, the pivot block 54 also defines a second vertical passageway 54H that extends entirely through the pivot block 54 between the top surface 54E and the bottom surface 54F along an axis that is parallel with the vertical axis “Z”. In the illustrated embodiment, the first and second vertical passageways 54G, 54H are parallel with one another and are defined at different position in the pivot block 54; specifically, the first vertical passageway 54G is defined proximate to the right side 54D of the pivot block 54, and the second vertical passageway 54H is defined proximate to the left side 54C of the pivot block 54.

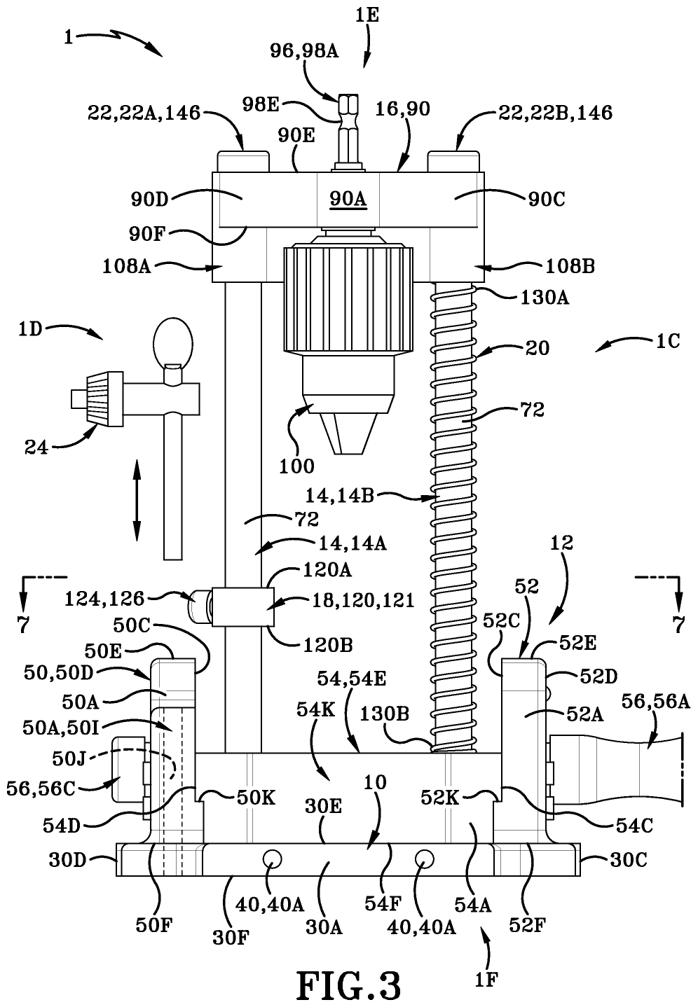

Referring to FIG. 4, the pivot block 54 also defines a longitudinal passageway 54I. The longitudinal passageway 54I is defined between proximate to the rear end 54B of the pivot block 54. The longitudinal passageway 54I also extends between the left side 54C and the right side 54D in which the left side 54C and the right side 54D are in fluid communication with one another at the longitudinal passageway 54I. Upon assembly of the drill guide 1, the longitudinal passageway 54I is axially aligned with the upper slots 50G, 52G defined in the first and second upright supports 50, 52. Such use and purpose of the longitudinal passageway 54I is described in more detail below.

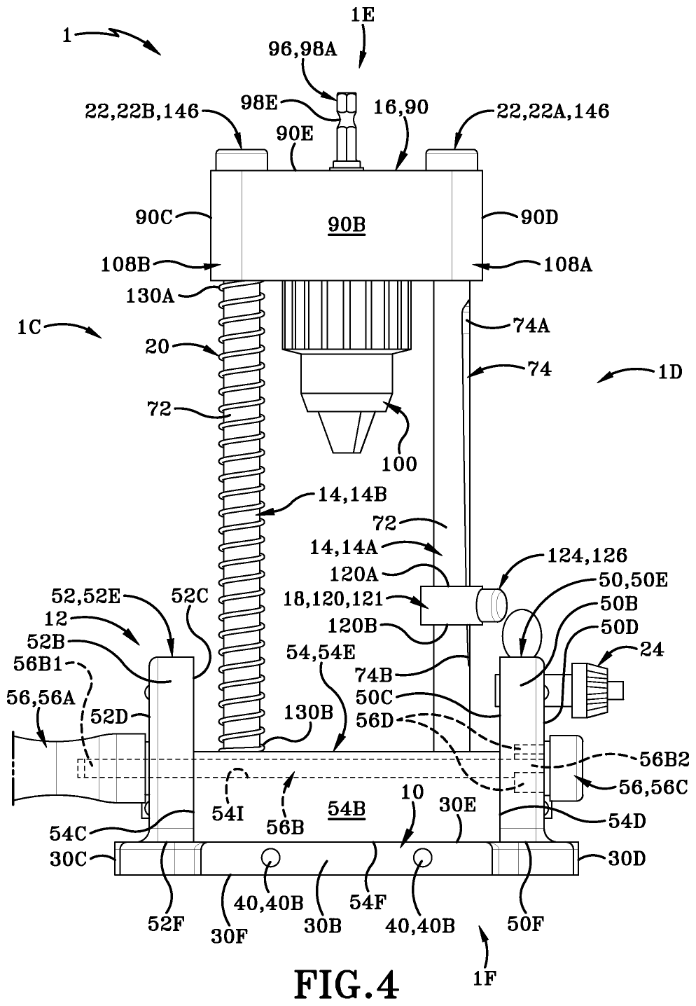

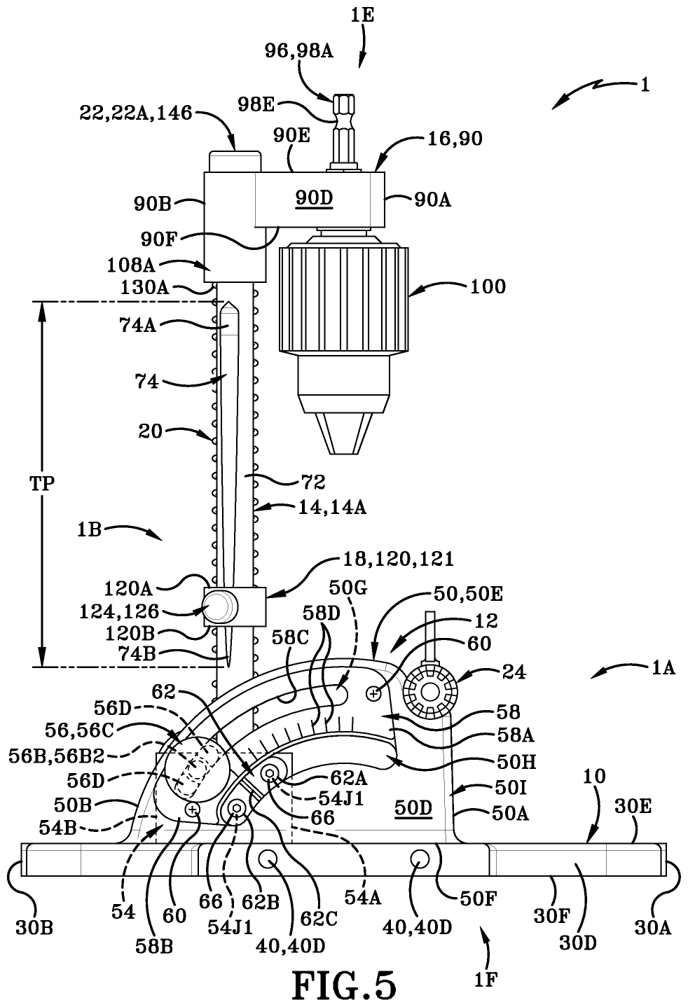

Referring to FIGS. 5 and 6, the pivot block 54 also defines a set of threaded openings in one or both of the left side 54C and the right side 54D. In the illustrated pivot block 54, the pivot block 54 defines a first set of threaded openings 54J1 that extends inwardly from the right side 54D of the pivot block 54 towards the left side 54C of the pivot block 54. The first set of threaded openings 54J1 is also aligned with the upper slot 50G of the first upright support 50 once the drill guide 1 is assembled. Similarly, the pivot block 54 defines a second set of threaded openings 54J2 that extends inwardly from the left side 54C of the pivot block 54 towards the right side 54D of the pivot block 54. The second set of threaded openings 54J2 is also aligned with the upper slot 52G of the second upright support 52 once the drill guide 1 is assembled. Such use and purpose of the first and second sets of threaded openings 54J1, 54J2 are described in more detail below.

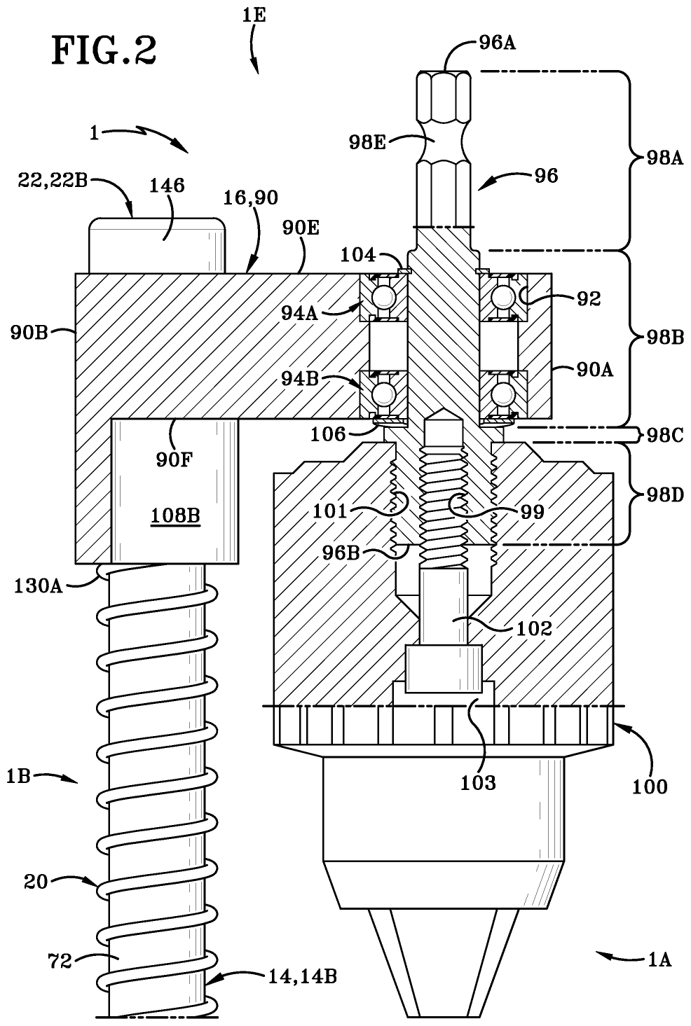

Referring to FIGS. 1 and 3, the pivot block 54 also defines a notch 54K at the front end 54A of the pivot block 54. The notch 54K defines an arcuate or curvilinear shape that extends inwardly from the front end 54A and towards the rear end 54B. The notch 54K enables a woodworker to select different types of drilling bits (e.g., twist drilling bits, flat bottom boring bits such as forstner bits, mortising bits, spade bits, and other suitable types of drilling bits of the like) without the pivot block interfering with and/or hindering the drilling capabilities of the selected drill but during woodworking projects. In other exemplary embodiment, a notch defined in a pivot block may have any suitable shape, size, or configuration based on various considerations, including the types of drilling bits a drill guide is configured to use for a woodworking project. In the illustrated pivot block 54, the top surface 54E and the bottom surface 54F are also in fluid communication with one another via the notch 54K.

Referring to FIGS. 1 and 3-7, the pivot assembly 12 includes an adjustment assembly 56 operably engages the pivot block 54 with the first upright support 50 and the second upright support 52. In the illustrated embodiment, the adjustment assembly 56 includes a handle 56A, a shaft 56B having a first end 56B1 operably engaged with the handle 56A and a second end 56B2 opposite to the first end 5661, and a guide member 56C operably engaged with the second end 5662 of the shaft 56B. The guide member 56C also includes at least one extension 56D that extend outwardly away from the guide member 56C and into the lower slot 50H of the first upright support 50 upon assembly, which is described in more detail below. In the illustrated guide member 56C, the guide member 56C includes a pair of extensions 56D that extend outwardly away from the guide member 56C and into the lower slot 50H of the first upright support 50 upon assembly.

Upon assembly of the pivot block 54 with the first upright support 50 and the second upright support 52, the handle 56A is positioned proximate to the second upright support 52 near the outer surface 52D of the second upright support 52. Upon assembly of the pivot block 54 with the first upright support 50 and the second upright support 52, the shaft 56B operably engages with the first upright support 50, via the upper slot 50G, the second upright support 52, via the upper slot 52G, and the pivot block 54, via the longitudinal passageway 54I. Upon assembly of the pivot block 54 with the first upright support 50 and the second upright support 52, the pair of extensions 56D of the guide member 56C operably engage with the first upright support 50 via the upper slot 50G.

In the illustrated adjustment assembly 56, the handle 56A and the guide member 56C are releasably secured with the first and second upright supports 50, 52 between an engaged positioned and a released position for enabling a woodwork to drill angled holes into a workpiece with the drill guide 1, which is described in more detail below. As such, the handle 56A may be releasably secured and/or threadably attached with the guide member 56C, via the shaft 56B, for providing the adjustment assembly 56 between the engaged position and the released position with the first and second upright supports 50, 52. In the engaged position, the handle 56A provides a first pressing force against the first upright support 50, and the guide member 56C provides a second pressing force against the second upright support 52 to maintain the drill guide 1 at a fixed position relative to the base plate 10. In the released position, the handle 56A and the guide member 56C are positioned at a distance away from the first and second upright supports 50, 52 and operably disengaged from the first and second upright supports 50, 52 to allow pivot the drill grill to another position relative to the base plate 10.

Referring to FIGS. 1 and 5-6, the pivot assembly 12 also includes at least one protractor that operably engages with one or both of the first upright support 50 and the second upright support 52. In the illustrated embodiment, the pivot assembly 12 includes a first protractor 58 that operably engages with the first upright support 50; more particularly, the first protractor 58 that operably engages with the outer surface 50D of the first upright support 50. In the illustrated embodiment, the pivot assembly 12 also includes a second protractor 59 that operably engages with the second upright support 52; more particularly, the second protractor 59 that operably engages with the outer surface 52D of the second upright support 52. The first protractor 58 and the second protractor 59 are substantially similar to the one another and operably engaged with the first upright support 50 and the second upright support 52 in a mirrored-image orientation. Inasmuch as the first and second protractors 58, 59 are substantially similar, the following description will relate to the first protractor 58. It should be understood, however, that the description of the first protractor 58 is applied substantially equal to the second protractor 59.

Referring to FIG. 5, the first protractor 58 has a front end 58A and a rear end 58B opposite to the front end 58A. The first protractor 58 also defines a slot 58C that extends longitudinally between the front and rear ends 58A, 58B and extend entirely through the first protractor 58. Upon assembly, the slot 58C of the first protractor 58 is aligned with the upper slot 50G of the first upright support 50 when the first projector 58 operably engages with the outer surface 50D of the first upright support 50. The first projector 58 also 58 includes a set of indicia 58D that is provided along a length of the first protractor 58 between the front end 58A and the rear end 58B. The set of indicia 58D indicates a ranges of angles in which the drill guide 1 is capable of angling a drilling bit relative to the base plate 10 via the pivot assembly 12. In the illustrated embodiment, the set of indicia 58D provides a range of angles from about zero degrees up to about forty degrees in which the drill guide 1 is capable of angling a drilling bit relative to the base plate 10 via the pivot assembly 12. In other exemplary embodiments, the set of indicia 58D may provide any suitable range of angles in which the drill guide 1 is capable of angling a drilling bit relative to the base plate 10, via the pivot assembly 12, for enabling a woodworker to drill various angled holes into different types of workpiece for various woodworking projects.

As described previously, the second protractor 59 is substantially similar to first protractor 58. As such, a front end 59A, a rear end 59B, a slot 59C, and a set of indicia 59D are substantially similar to the front end 58A, rear end 58B, slot 58C, and the set of indicia 58D of the first protractor 58. In the illustrated embodiment, the slot 59C aligns with the upper slot 52G of the second upright support 52 when the second protractor 59 operably engages with the outer surface 52D of the second upright support 52.

Referring to FIGS. 5 and 6, a set of connectors 60 operably engages the first and second protractors 58, 59 with the first and second upright supports 50, 52. In the illustrated embodiment, a set of connectors 60 threadably engage the first and second protractors 58, 59 with the first and second upright supports 50, 52. In other exemplary embodiments, first and second protractors may be operably engaged with the first and second upright supports in any suitable way. Examples of operably engaging first and second protractors with first and second upright supports include attaching, affixing, connecting, coupling, fastening, joining, linking, locking, mounting, press-fitting, securing, and other suitable ways of operably engaging first and second protractors with first and second upright supports.

Still referring to FIGS. 5 and 6, a set of bearings operably engage with the pivot block 54 via the set of threaded openings 54J1, 54J2, which is described in more detail below. In the illustrated embodiment, the pivot assembly 12 includes a first bearing 62 that operably engages with the pivot assembly 12 at the threaded openings 54J1, and the pivot assembly 12 includes a second bearing 64 that operably engages with the pivot assembly 12 at the threaded openings 54J2. The first and second bearings 62, 64 are substantially similar to one another and operably engage with the pivot block 54 is a mirrored-image orientation. Inasmuch as the first and second bearings 62, 64 are identical, the following description relates to the first bearing 62. It should be understood, however, the description of the first bearing 62 applies substantially equally to the second bearing 64.

As illustrated in FIG. 5, the first bearing 62 defines a first through-hole 62A at a first end and a second through-hole 62B at a second end opposite to the first end. The first and second through-holes 62A, 62B of the first bearing 62 are configured to receive connectors 66 that operably engage the first bearing 62 with the pivot block 54. More particularly, as illustrated in FIG. 5, a first connector 66A is received by the first through-hole 62A of the first bearing 62 and threadably engages with a first threaded opening of the set of threaded openings 54J1 to operably engage the first bearing 62 with the pivot block 54. Similarly, as illustrated in FIG. 5, a second connector 66B is received by the second through-hole 62B of the first bearing 62 and threadably engages with a second threaded opening of the set of threaded openings 54J1 to operably engage the first bearing 62 with the pivot block 54.

The first bearing 62 is also configured to be received by the lower slot 50H of the first upright support 50 when the first bearing 62 operably engages with the pivot block 54. During operation, the first bearing 62 is configured to be slideably moveable relative to the first upright support 50 inside of the lower slot 50H when the pivot block 54 is pivoted by the woodworker. As such, the first bearing 62 is configured to guide the pivot block 54 along the first upright support 50 via the lower slot 50H of the first upright support 50.

Still referring to FIG. 5, the first bearing 62 also has an indicator 62C that is positioned between the first through-hole 62A and the second through-hole 62B on the first bearing 62. The indicator 62C is configured to index and/or point to an angle from the range of angles defined by the set of indicia 58D of the first protractor 58 to show the angle of the pivot block 54 relative to the first upright support 50. As such, the indicator 62C enables a woodworker to accurately and precisely choose a desired angle for the drill guide 1 when drilling an angled hole into a workpiece; such drilling of an angled hole in a workpiece is described in more detail below.

As described previously, the second bearing 64 is substantially similar to the first bearing 62. As such, a first through-hole 64A, a second through-hole 64B, and an indicator 64C of the second bearing 64 is substantially similar to the first through-hole 62A, the second through-hole 62B, and the indicator 62C of the first bearing 62. In the illustrated embodiment, the second bearing 64 operably engages with the pivot block 54 via the threaded openings 54J2 with connectors 66C, 66D. The second bearing 64 is also configured to be received by the lower slot 52H of the second upright support 52 when the second bearing 64 operably engages with the pivot block 54. During operation, the second bearing 64 is configured to be slideably moveable relative to the second upright support 52 inside of the lower slot 52H when the pivot block 54 is pivoted by the woodworker. As such, the second bearing 64 is configured to guide the pivot block 54 along the second upright support 52 via the lower slot 52H of the second upright support 52.

Referring to FIGS. 1, 3-4, and 9, the drill guide includes at least one guide column 14 that operably engages with the pivot block 54 via at least one of the first vertical passageway 54G and the second vertical passageway 54H. In the illustrated embodiment, a first guide column 14A operably engages with the pivot block 54 via the first vertical passageway 54G, and a second guide column 14B operably engages with the pivot block 54 via the second vertical passageway 54H. The guide columns 14A, 14B are substantially similar to one another and are engaged with the one of the first vertical passageway 54G and second vertical passageway 54H in the same orientation. Inasmuch as the guide columns 14 are substantially similar, the following description will relate to the first guide column 14A. It should be understood, however, that the description of the first guide column 14A applies substantially equal to the second guide column 14B.

Referring to FIG. 9, the first guide column 14A has a top end or first end 70A, a bottom end or second end 70B that opposes the top end 70A, and a longitudinal axis that extends from the top end 70A to the bottom end 70B. The first guide column 14A also has an outer surface 72 that is disposed circumferentially about the longitudinal axis of the first guide column 14A between the top end 70A and the bottom end 70B. In the illustrated embodiment, the first guide column 14A also defines a tapered portion 74 that laterally extends into the first guide column 14A orthogonal to the longitudinal axis “X” of drill guide 1. The tapered portion 74 is a flattened surface that extends along the first guide column 14A orthogonal to the longitudinal axis “X” of drill guide 1. The tapered portion 74 has a first end 74A proximate to the top end 70A of the first guide column 14A, an opposed second end 74B proximate to the bottom end 70B of the first guide column 14A, and a length “TS” that is measured from the first end 74A to the second end 74B. In addition, the tapered portion 74 defines a first diameter “T₁” at the first end 74A of the tapered portion and a second diameter “T₂” at the second end 74B of the tapered portion 74. The length “TS” of the tapered portion is less than the overall length of the first guide column 14A measured from the top end 70A of the first guide column 14A to the bottom end 70B of the first guide column 14A. As illustrated in FIG. 9, the tapered portion 74 tapers in diameter from the second end 74B to the first end 74A where the second diameter “T₂” of the first guide column 14A proximate to the second end 74B of the tapered portion 74 is greater than the first diameter T₁” of the first guide column 14A proximate to the first end 74A of the tapered portion 74. In the illustrated embodiment, the first guide column 14A of the pair of guide columns is the only guide rod that has a tapered portion. In one exemplary embodiment, a first guide column and a second guide column may have a tapered portion. Such use of the tapered portion 74 of the first guide column 14A is described in more detail below.

Still referring to FIG. 9, the first guide column 14A has a first threaded passage 76A and a second threaded passage 76B. The first threaded passage 76A extends downwardly from the top end 70A of the first guide column 14A towards the bottom end 70B of the first guide column 14A relative to the longitudinal axis of the first guide column 14. As described later herein, the first threaded passage 76A operably engages the first guide column 14A to the chuck carrier 16. The second threaded passage 76B extends upwardly from the bottom end 70B of the first guide column 14A towards the top end 70A of the first guide column 14A relative to the longitudinal axis of the first guide column 14. The first guide column 14A also has a reduced portion 78 that extends from the bottom end 70B towards the top end 70A in which the reduced portion 78 has a smaller diameter than the rest of the first guide column 14A. The reduced portion 78 is sized and configured to be received by the first vertical passageway 54G of the pivot block 54 where the first guide column 14A is operably engaged with the base plate 10. In addition, a fastener 80 further operably engages the first guide column 14A to the pivot block 54 by operably fastening to the second threaded passage 76B of the first guide column 14A. Other suitable ways may be used to operably engage a first guide column to a pivot block. Examples of operably engaging a first guide column to a pivot block includes attaching, affixing, connecting, coupling, fastening, joining, linking, locking, mounting, press-fitting, securing, and other suitable ways of operably engaging a first guide column to a pivot block.

Referring now to FIGS. 1-2, the chuck carrier 16 includes housing 90. The housing 90 has a front end 90A, a rear end 90B that opposes the front end 90A, and a longitudinal axis defined between the front end 90A and the rear end 90B. The housing 90 also includes a left side or first side 90C, a right side or second side 90D that opposes the left side 90C, and a transverse axis that is defined between the left side 90C and the right side 90D. The housing 90 also includes a top surface 90E, a bottom surface 90F that opposes the top surface 90E, and a vertical axis defined between the top surface 90E and the bottom surface 90F. As shown in FIG. 2, the housing 90 defines a front through-hole 92 that extends entirely through the housing 90 from the top surface 90E to the bottom surface 90F relative to the vertical axis of the housing 90.

Still referring to FIG. 2, chuck carrier 16 includes at least one ball bearing 94. In the illustrated embodiment, the chuck carrier 16 includes an upper ball bearing 94A and a lower ball bearing 94B. The upper ball bearing 94A is disposed inside of the front through-hole 92 and operably engages with the housing 90 inside of said front through-hole 92. In the illustrated embodiment, the upper ball bearing 94A is press-fitted into the housing 90 via the front through-hole 92. In other exemplary embodiments, any suitable engagement for maintaining an upper ball bearing inside of a housing may be used. The upper ball bearing 94A is disposed proximate to the top surface 90E of the housing 90 such that the upper ball bearing 94A is even with the top surface 90E of the housing 90 and fails to protrude outside of the front through-hole 92. The lower ball bearing 94B is also disposed inside of the front through-hole 92 and operably engages with the housing 90 inside of said first through-hole 92. In the illustrated embodiment, the lower ball bearing 94B is press-fitted into the housing 90 via the front through-hole 92. In other exemplary embodiments, any suitable engagement for maintaining a lower ball bearing inside of a housing may be used. The lower ball bearing 94B is disposed proximate to the bottom surface 90F of the housing 90 such that the lower ball bearing 94B is even with the bottom surface 90F of the housing 90 and fails to protrude outside of the front through-hole 92. In the illustrated embodiment, the upper ball bearing 94A is disposed above the lower ball bearing 94B relative to the vertical axis of the housing 90.

Still referring to FIG. 2, the chuck carrier 16 also includes a hex bit 96 that has a top or first end 96A and an opposed bottom or second end 96B. A hex portion 98A of the hex bit 96 defined from the first end 96A to the top surface 90E of the housing 90 is disposed exterior to the front through-hole 92. As described in more detail herein, the hex portion 98A allows a portable power drill to operably engage with the hex bit 96. A blanked portion 98B of the hex bit 96 defined between the top surface 90E of the housing 90 to the bottom surface 90F of the housing 90 operably engages with the upper ball bearing 94A and the lower ball bearing 94B inside of the front through-hole 92. The mechanical engagement between the hex bit 96 and the upper ball bearing 94A and lower ball bearing 94B allows the upper ball bearing 94A and lower ball bearing 94B to support rotational movement of the hex bit 96 during a drilling operation. In other words, the upper ball bearing 94A and lower ball bearing 94B allows the hex bit 96 to freely rotate inside of the front through-hole 92 without any interruption caused by the housing 90. A shoulder 98C of the hex bit 96 is defined between the blanked portion 98B and a threaded portion 98D that prevents the hex bit 96 from backing out from the housing 90 once the hex bit 96 is assembled to the housing 90. The hex bit 96 also has threaded portion 98D that is defined between the shoulder 98C and the second end 96B of the hex bit 96. The use of the threaded portion 98D of the hex bit 96 is described in more detail below. The hex bit 96 also defines a threaded opening 99 that extends upwardly from the second end 96B of the hex bit 96 towards the first end 96A of hex bit 96 where the threaded opening 99 is defined inside of the threaded portion 98D, the shoulder 98C, and a portion of the blanked portion 98B.

Still referring to FIG. 2, the hex bit 96 also defines an annular concave groove 98E. The annular concave groove 98E that extends between the hex portion 98A and the blanked portion 98B on the hex bit 96. As described in more detail herein, the annular concave groove 98E may allow a portable drill that includes a quick release to operably engage with the hex bit 96 during a drilling operation. Such types of portable drills are described in more detail below.

Still referring to FIG. 2, the chuck carrier 16 also includes a drill chuck 100. The drill chuck 100 defines a threaded channel 101 that operably engages the hex bit 96 with the drill chuck 100. In the illustrated embodiment, the threaded portion 98D of the hex bit 96 operably fastens to the threaded channel 101 of the drill chuck 100. In addition, a connector 102 passes through a non-threaded channel 103 defined by the drill chuck 100 and operably fastens the drill chuck 100 to the hex bit 96. Upon assembly, the hex bit 96 and the drill chuck 100 may collectively rotate together during a drilling operation via a rotational force exerted by a portable power drill, which is described in more detail below.

In the illustrated embodiment, the drill chuck 100 is offset from the first and second guide columns 14A, 14B of the drill guide 1 in which the drill chuck 100 and the first and second guide columns 14A, 14B are positioned in different planes relative to the transverse axis “Y” of the drill guide 1. As illustrated in FIG. 9, the first and second guide columns 14A, 14B are positioned in common plane where the first and second guide columns 14A, 14B are positioned in a plane “P” that extends between the left and right sides 1C, 1D of the drill guide 1 parallel with the transverse axis “Y”.

The chuck carrier 16 may include any suitable drill chuck 100 in the drill guide 1. In the illustrated embodiment, the chuck carrier 16 uses a keyed drill chuck, via a matching drill chuck key 24 (see FIG. 3), for the drill chuck 100 on the drill guide 1. Such storage of the drill chuck key 24 is described in more detail below. In another exemplary embodiment, a chuck carrier may include a keyless drill chuck for a drill chuck on a drill guide.

Still referring to FIG. 2, a retaining ring 104 is operably engaged to the blanked portion 98B of the hex bit 96. The retaining ring 104 directly abuts the top surface 90E of the housing 90 to provide a suitable support between the hex bit 96 and the housing 90 for holding and maintaining the position of the hex bit 96 inside of the housing 90. In addition, a curved washer 106 is operably engaged to the hex bit 96 and the housing 90 in which the curved washer 106 is provided between the shoulder 98C of the hex bit 96 and the bottom surface 90F of the housing. In this illustrated embodiment, the curved washer 106 provides a spring-like profile and/or structural configuration to absorb light mechanical loads for keeping the hex bit 96 and associated parts operably engaged to the hex bit 96 in place during operation.

Referring now to FIGS. 1A and 9, the housing 90 has a first protrusion 108A and a second protrusion 108B. The first protrusion 108A extends downwardly from the housing 90 away from the bottom surface 90F relative to the vertical axis of the chuck carrier 16 and towards the base plate 10. The first protrusion 108A is positioned proximate to the rear end 90B and the right side 90D. The first protrusion 108A defines a first rear through-hole 110A that extends entirely through the chuck carrier 16 and the first protrusion 108A from the top surface 90E to the bottom surface 90F relative to the vertical axis of the chuck carrier 16. The second protrusion 108B extends downwardly from the housing 90 away from the bottom surface 90F relative to the vertical axis of the chuck carrier 16 and towards the base plate 10. The second protrusion 108B is positioned proximate to the rear end 90B and the left side 90C. The second protrusion 108B defines a second rear through-hole 110B that extends entirely through the chuck carrier 16 and the second protrusion 108B from the top surface 90E to the bottom surface 90F relative to the vertical axis of the chuck carrier 16.

Referring to FIG. 9, an upper bushing 112A and a lower busing 112B are provided inside each of the first rear through-hole 110A and the second rear through-hole 110B. Since both the upper bushing 112A and the lower bushing 112B are arranged identically in the first protrusion 108A and the second protrusion 108B, the structural arrangement of the upper bushing 112A and the lower bushing 112B inside of the first rear through-hole 110A of the first protrusion 108A will be described. It should be understood that while the structural arrangement of the upper bushing 112A and the lower bushing 112B inside of the first rear through-hole 110A of the first protrusion 108A is being described, such description is applied identically to the upper bushing 112A and the lower bushing 112B inside of the second rear through-hole 110B of the second protrusion 108B.

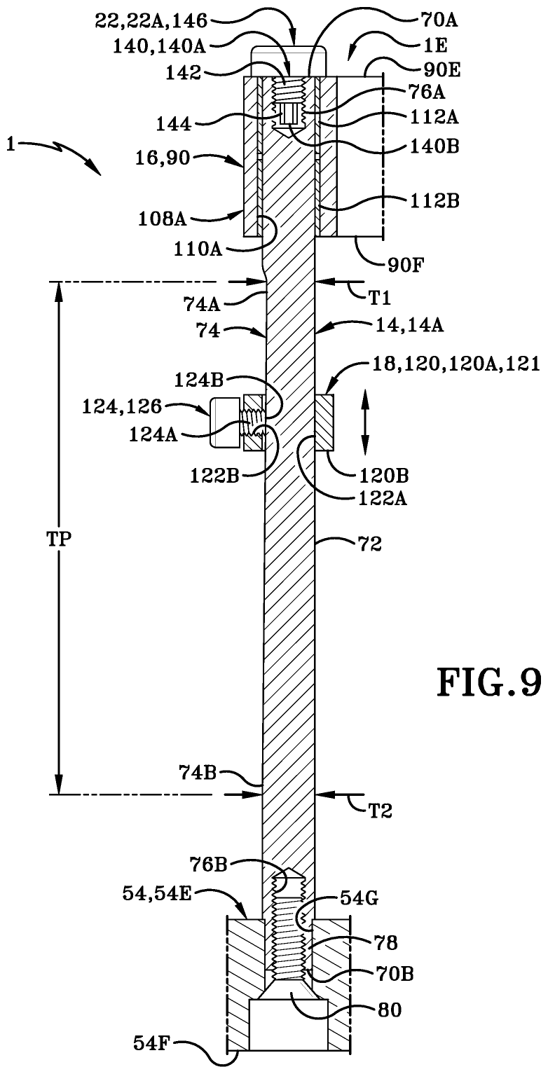

As shown in FIG. 10, the upper bushing 112A is disposed inside of the first rear through-hole 110A and operably engages the housing 90 inside of said first rear through-hole 110A. In the illustrated embodiment, the upper bushing 112A is press-fitted into the first protrusion 108A of the housing 90 via the first rear through-hole 110A. In other exemplary embodiments, any suitable engagement for maintaining an upper bushing inside of a first protrusion of a housing may be used. The upper bushing 112A is disposed proximate to the top surface 90E of the housing 90 such that the upper bushing 112A is even with the top surface 90E of the housing 90 and fails to protrude outside of the first rear through-hole 110A. Still referring to FIG. 9, the lower bushing 112B is disposed inside of the first rear through-hole 110A and operably engages the housing 90 inside of said first rear through-hole 110A. In the illustrated embodiment, the lower bushing 112B is press-fitted into the first protrusion 108A of the housing 90 via the first rear through-hole 110A. In other exemplary embodiments, any suitable engagement for maintaining a lower bushing inside of a first protrusion of a housing may be used. The lower bushing 112B is disposed proximate to the bottom surface 90F of the housing 90 such that the lower bushing 112B is even with the bottom surface 90F of the housing 90 and fails to protrude outside of the first rear through-hole 110A. In the illustrated embodiment, the upper ball bushing 112A is disposed above the lower bushing 112B relative to the vertical axis of the housing 90.

Still referring to FIG. 9, the upper bushing 112A and the lower bushing 112B operably engage to the outer surface 72 of the first guide column 14A inside of the first rear through-hole 110A. Similarly, the upper bushing 112A and the lower bushing 112B operably engage to the outer surface 72 of the second guide column 14B inside of the second rear through-hole 110B. The use of the upper bushing 112A and the lower bushing 112B being positioned between each guide column 14A, 14B and the chuck carrier 16 is considered advantageous at least because the upper bushing 112A and the lower bushing 112B allow the chuck carrier 16 to freely move along the outer surfaces 72 of the first and second guide columns 14A, 14B for plunging a drilling bit into a workpiece, which is described in more detail below. In addition, the upper bushing 112A and the lower bushing 112B being positioned between each guide column 14A, 14B and the chuck carrier 16 may be formed of any suitable material. In one exemplary embodiment, an upper bushing and a lower bushing positioned between guide columns and a chuck carrier may be formed of a polymer material. In another exemplary embodiment, an upper bushing and a lower bushing positioned between guide columns and a chuck carrier may be formed of Teflon™.

Referring now to FIGS. 1, 3-5, 7, and 9, a depth stopper 18 is provided on the first guide column 14A. The depth stopper 18 has a collar 120 that defines a top surface 120A and an opposed bottom surface 120B joined by a circumferential wall 121. The collar 120 also defines a longitudinal axis between the top surface 120A and the bottom surface 120B. The depth stopper 18 also defines a central opening 122A that extends entirely through the collar 120 from the top surface 120A to the bottom surface 120B relative to longitudinal axis of the collar 120. The central opening 122A is sized and configured to receive and house a portion of the first guide column 14A. As illustrated in FIG. 9, the depth stopper 18 also defines a threaded side opening 122B disposed between the top surface 120A and the bottom surface 120B and extends entirely through circumferential wall 121. In this illustrated embodiment, the threaded side opening 122B is in fluid communication with the central opening 122A. Such use of the threaded side opening 122B is described in more detail below.

In addition, a depth stopper 18 includes a fastener 124. The fastener 124 has a threaded shaft 124A that is sized and configured to operably engage with the threaded side opening 122B of the collar 120. In other words, the threaded shaft 124A operably threads to the threaded side opening 122B of the collar 120. The fastener 124 also includes an engaging end 124B that operably engages with the tapered portion 74 of the first guide column 14A. The fastener 124 also includes a knob 126 that is provided on the threaded shaft 124A. The knob 126 allows a woodworker to tighten and/or loosen the fastener 124 for maintaining and/or moving the position of the collar 120 on the first guide column 14A. When the fastener 124 is tightened to the first guide column 14A, the threaded shaft 124A extends through the threaded side opening 122B and into the central opening 122A to allow the engaging end 124B of the fastener 124 to operably engage the tapered portion 74 of the first guide column 14A (see FIG. 9). The structural configuration between the fastener 124 of the depth stopper 18 and the tapered portion 74 of the first guide column 14A is considered advantageous at least because the tapered portion 74 provides a self-tightening mechanism between the depth stopper 18 and the first guide column 14A. The self-tightening mechanism provided by the tapered portion 74 to the fastener 124 occurs because the tapered portion 74 keeps reducing as the tapered portion 74 progresses to the bottom end 70B of the first guide column 14A. In other words, the diameter of the tapered portion 74 proximate to the top end 70A of the first guide column 14A is less than the diameter proximate to the bottom end 70B of the first guide column 14A. When the fastener 124 is loosened from the first guide column 14A, the threaded shaft 124A backs into the threaded side opening 122B and away from the central opening 122A to allow the collar 120 to freely move along the tapered portion 74 and the outer surface 72 of the first guide column 14A.

The depth stopper 18 is considered advantageous at least because the depth stopper 18 limits the downward travel of the chuck carrier 16 and all associated components on the chuck carrier 16 at a specific location of the tapered portion 74 on the first guide column 14A. With the inclusion of the tapered portion 74, the depth stopper 18 remains at the desired location along the first guide column 14A even when the chuck carrier 16 is exerted against the depth stopper 18 (via the woodworker) due to the self-tightening mechanism between the depth stopper 18 and the first guide column 14A. In other words, the fastener 124 operably engaged with the collar 120 fails to move downwardly due to the tapered portion 74 preventing the fastener 124 from sliding and/or moving down the first guide column 14A during one or more contacts with the chuck carrier 16 during a drilling operation.

Referring now to FIGS. 1, 2, 4, and 6, the biaser 20 has a top end or first end 130A, an opposed bottom end or second end 130B, and a longitudinal axis that extends between the top end 130A to the bottom end 130B. In the illustrated embodiment, the biaser 20 is circumferentially disposed about the second guide column 14B. As illustrated in FIG. 6, the top end 130A of the biaser 20 operably engages the lower surface of the second protrusion 108B on the chuck carrier 16 in which the top end 130A of the biaser 20 directly abuts the lower surface of the second protrusion 108B on the chuck carrier 16. As illustrated in FIG. 4, the bottom end 130B of the biaser 20 operably engages the second extension 48 of the base plate 10. In other words, the bottom end 130B of the biaser 20 directly abuts a top surface of the second extension 48 of the base plate 10. In the illustrated embodiment, the biaser 20 is configured to bias the chuck carrier 16, and associated components provided on the chuck carrier 16, towards the top end 1E of the drill guide 1 and away from the base plate 10 relative to the vertical axis “Z.” In the illustrated embodiment, the biaser 20 is a compression spring that is configured to oppose compression and return to its uncompressed length when the applied force is removed. In another exemplary embodiment, any suitable type of biaser may be used to bias a chuck carrier, and associated components provided on the chuck carrier, towards a top end of a drill guide and away from a base plate of the drill guide relative to a vertical axis of the drill guide.

The biaser 20 is considered advantageous at least because the biaser 20 assists a woodworker in moving the chuck carrier 16 and associated components provided on the chuck carrier 16 away from a workpiece after drilling a hole in said workpiece. In other words, the biaser 20 returns the chuck carrier 16 and associated components provided on the chuck carrier 16 to its original, pre-drilling position without the woodworker exerting a force on the drill guide 1 to move the chuck carrier 16.

Referring to FIGS. 1 and 1A, at least one locking knob 22 is provided in the drill guide 1. In the illustrated embodiment, the drill guide 1 provides a first locking knob 22A and a second locking knob 22B that operably engage with one of the first guide column 14A and the second guide column 14B. The locking knobs 22A, 22B are substantially similar to one another and are engaged with one of the first guide column 14A and the second guide column 14B in the same orientation. Inasmuch as the locking knobs 22 are substantially similar, the following description will relate to the first locking knob 22A. It should be understood, however, that the description of the first locking knob 22A applies equally to the second locking knob 22B.

Referring to FIG. 1A, the first locking knob 22A includes a shaft 140 that has a first end 140A, an opposed second end 140B, and a longitudinal axis defined between the first end 140A and the second end 140B. The shaft 140 has a threaded portion 142 that extends from the first end 140A to a key portion 144 of the shaft 140. As shown in FIG. 9, the threaded portion 142 is sized and configured to operably engage with the first threaded passage 76A of the first guide column 14A. In other words, the threaded portion 142 is sized and configured to operably thread with the first threaded passage 76A of the first guide column 14A. The key portion 144 of the shaft 140 extends from the threaded portion 142 to the second end 140B of the shaft 140. As shown in FIG. 9, the key portion 144 is sized and configured to be received by the first threaded passage 76A such that the key portion 144 is housed inside of the first threaded passage 76A of the first guide column 14A. As described in more detail herein, the key portion 144 of the first locking knob 22 may operably engage with the fence assembly 200 and other various components and parts of assemblies used with the drill guide 1 described and illustrated herein or available to be used with the illustrated drill guide. Such engagement is described in more detail below. Referring to FIG. 1A, a knob 146 is provided at the first end 140A of the shaft 140 for allowing a woodworker to tighten and/or loosen the first locking knob 22A from and/or to the first guide column 14A and to manipulate the first locking knob 22A when needed. As illustrated in FIG. 9, the engagement between the first locking knob 22A and the first guide column 14A limits the travel of the chuck carrier 16 when traveling away from the base plate 10 and towards the first end 70A of the first guide column 14A. The first locking knob 22A limits the travel of the chuck carrier 16 by having a lower surface of the knob 146 (proximate to the first end 140A of shaft 140) directly abutting the top surface 90E of the housing 90 while the first locking knob 22A is operably fastened to the first guide column 14A.

In the illustrated embodiment, the key portion 144 of the locking knobs 22 is hexagonal-shaped (e.g. Allen wrench style key). While the key portion 144 of the locking knobs 22 is hexagonal-shaped, any suitable shape or configuration for a key portion on a locking knob may be used. Examples of suitable shapes or configuration for a key portion on a locking knob include flat style key, Philips style key, torx style key, square style key, star style key, and any other suitable shapes or configurations for a key portion on a locking knob for a particular embodiment.

Referring to FIGS. 1 and 3, the drill chuck key 24 is configured to loosen and tighten the keyed drill chuck 100 with a drilling bit during woodworking projects, which is described in more detail below. As illustrated in FIG. 3, the drill chuck key 24 is moveable between a stored position and an operating position. In the stored position, the drill chuck key 24 is configured to be stored in the cavity 50J of the first upright support 50 when the drill chuck key 24 is not needed.

As illustrated in FIGS. 10-12 and 14, the fence assembly 200 includes a fence 202, at least one thumb screw 204 operably engaged with the fence 202, and at least one guide rod 206 operably engaged with both the fence 202 and the at least one thumb screw 204. In the illustrated embodiment, the at least one guide rod 206 operably engages with base plate 10 of the drill guide 1 for operably engaging the fence 202 with the base plate 10 for a drilling operation. Such use of the fence assembly 200 with the drill guide 1 during a drilling operation is described in more detail below.

As illustrated in FIG. 10, the fence 202 includes a plate 210. The plate includes a front end 210A, a rear end 210B that opposes the front end 210A, and a longitudinal axis that extends between the front end 210A and the rear end 210B. The plate 210 also includes a left side or first side 210C, a right side or second side 210D that opposes the left side 210D, and a transverse axis that extends between the left side 210C and the right side 210D. The plate 210 also includes a first top surface 210E, a bottom surface 210F that opposes the first top surface 210E, and vertical axis that extends between the first top surface 210E and the bottom surface 210F. The plate 210 may also include a notch 211 that extends into the front end 210A of the fence 202. During woodworking projects, the notch 211 may enable a woodworker to align the plate 210 with a witness line or other relevant marker scribed on a workpiece such that the drill guide 1 and the fence assembly 200 are aligned at a desired position on the workpiece.

Still referring to FIG. 10, the fence 202 includes a step 212. In the illustrated embodiment, the fence 202 and the step 212 is a unibody component that is integrally extruded, molded, printed, or additively manufactured, removably machined, or formed as a unitary, monolithic member substantially fabricated from a rigid, manmade, material. In one example, metal or metal alloys, such as stainless steel or aluminum alloy, may form a substantial majority of the components or elements used to fabricate the fence and the various components integrally formed, molded, or extruded therewith. The rigid fence should withstand typical woodworking handling from an operator pressing the fence against a piece of wood without damaging the fence. While it is contemplated that the fence 202 and its additional components described herein are uniformly and integrally extruded, molded, or formed, it is entirely possible that the components of the fence be formed separately from alternative materials as one having routine skill in the art would understand. Furthermore, while the components of the fence are discussed below individually, it is to be clearly understood that the components and their corresponding reference elements of the fence are portions, regions, or surfaces of the body and all form a respective element or component of the unitary tool body. Thus, while the components may be discussed individually and identified relative to other elements or components of the fence, in this exemplary embodiment, there is a single fence having the below described portions, regions, or surfaces.

Still referring to FIG. 10, the step 212 is positioned proximate to the rear end 210B of the plate 210 and extends upwardly from the plate 210. The step 212 includes a front end 212A that is parallel with the front end 210A of the plate 210, a rear end 212B that is parallel with rear end 210B of the plate 210, and a longitudinal axis that is parallel with the longitudinal axis of the plate 210. The step 212 also includes a left side or first side 212C that is parallel with the left side 210C of plate 210, a right side or second side 212D that is parallel with the right side 210D of the plate 210, and a transverse axis that is parallel with the transverse axis of the plate 210. The step 212 also includes a second upper surface 212E that is parallel with the first top surface 210E of the plate 210. In the illustrated embodiment, each of the front surface 212A, the rear surface 212B, left side 212C, right side 212D, and second top surface 212 is disposed above the front surface 210A, the rear surface 210B, left side 210C, right side 210D, and first top surface 210E relative to the vertical axis of the plate 210.

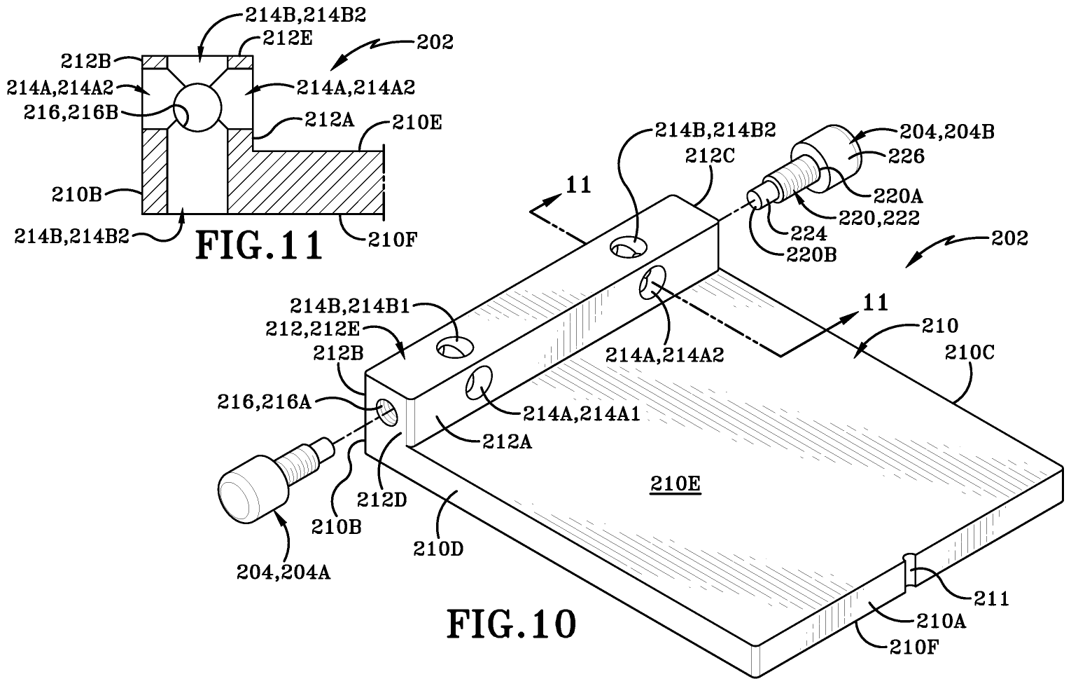

Referring to FIGS. 10 and 11, the step 212 defines a first set of passageways 214A that extends entirely through the step 212 from the front end 212A to the rear end 212B relative to the longitudinal axis of the step 212. The step 212 also defines a second set of passageways 214B that extends entirely through the step 212 and the plate 210 from the second upper surface 212E of the step 212 to the bottom surface 210F of the plate 210. In the illustrated embodiment, the first set of passageways 214A and the second set of passageways 214B are defined orthogonally to one another and are in fluid communication with one another. In one example, a first passageway 214A1 of the first set of passageways 214A is defined perpendicular to a first passageway 214B1 of the second set of passageways 214B where the first passageways 214A1, 214B1 are in fluid communication with one another. As described in more detail herein, the at least one guide rod 206 may operably engage with fence 202 via one of the first set of passageways 214A and the second set of passageways 214B. Such engagement between the fence 202 and the at least one guide rod 206 is described in more detail below.

Still referring to FIGS. 10 and 11, the step 212 also defines a set of threaded passageways 216 that extends into the step 212. As illustrated in FIG. 11, a first threaded passageway 216A of the set of threaded passageways 216 extends from the right side 212D of the step 212 and into the step 212 relative to the transverse axis of the step 212. In the illustrated embodiment, the first threaded passageway 216A is perpendicular to the first passageways 214A1, 214B1 and in fluid communication with said first passageways 214A1, 214B1. The second threaded passageway (not illustrated) extends from the right side 212D of the step 212 and into the step 212 relative to the transverse axis of the step 212. The second threaded passageway is also perpendicular to second passageways 214A2, 214E32 of the first and second sets of passageways 214A, 214B and in fluid communication with said second passageways 214A2, 214B2.

Referring now to FIG. 10, the at least one thumb screw 204 includes a first thumb screw 204A and a second thumb screw 204B that operably engage the one of the threaded passageways of the set of threaded passageways 216 of the fence 202. The thumb screws 204A, 204B are substantially similar to one another and are engaged with one of the threaded passageways 216 on the fence 202 in the same orientation. Inasmuch as the thumbs screws 204 are substantially similar, the following description will relate to the second thumb screw 204B. It should be understood, however, that the description of the second thumb screw 204B applies equally to the first thumb screw 204A.

Still referring to FIG. 11, the thumb screw 204 includes a shaft 220. The shaft 220 has a first end 220A, an opposed second end 220B, and a longitudinal axis that extends from the first end 220A to the second end 220B. The shaft 220 includes a threaded portion 222 that extends from the first end 220A to a blanked portion 224 of the shaft 220. The threaded portion 222 operably engages with one of the threaded passageways 216A, 216B of the set of threaded passageways 216 to maintain the thumb screw 204 inside of the fence 202 (seen in FIG. 14). The blanked portion 224 of the shaft 220 extends from the threaded portion 222 to the second end 220B of the shaft 220. As described in more detail herein, the blanked portion 224 operably engages with the at least one fence guide rod 206 when the at least one fence guide rod 206 operably engages the fence 202. In addition, a knob 226 is provided at the first end 220A of the shaft 220 for allowing a woodworker to tighten and/or loosen the thumb screw 204 from the fence 202. Such manipulation of the thumb screw 204 during a drilling operation is described in more detail below.

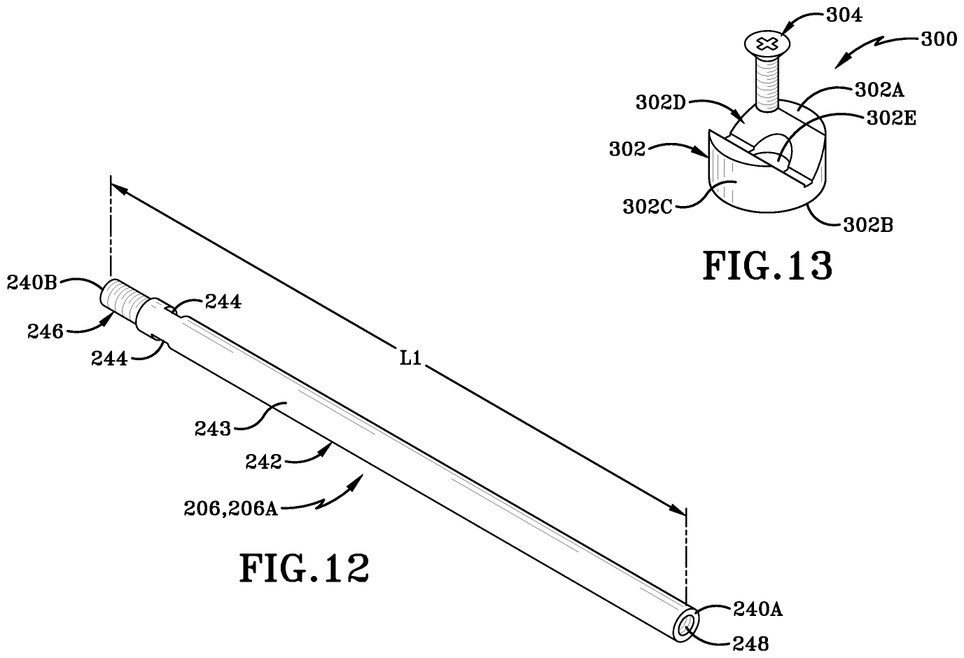

Referring now to FIG. 12, the fence assembly 200 includes the at least one guide rod 206. In the illustrated embodiment, the at least one guide rod 206 includes a first guide rod 206A and a second guide rod 206B that operably engage with the fence 202 inside of one of the passageways of the first set of passageways 214A or one of the passageways of the second set of passageways 214B. The first guide rod 206A and the second guide rod 206B are substantially similar to one another and are engaged with one of the passageways of the first set of passageways 214A or one of the passageways of the second set of passageways 214B in the same orientation. Inasmuch as the guide rods 206 are substantially similar, the following description will relate to the first guide rod 206A. It should be understood, however, that the description of the first guide rod 206A applies equally to the second guide rod 206B.

Still referring to FIG. 12, the first guide rod 206A has a front end or first end 240A, an opposed rear end or second end 240B, and a length “L1” that is measured from the front end 240A to the rear end 240B. The first guide rod 206A has a blanked portion 242 that extends from the front end 240A to a threaded portion 246. The first guide rod 206A defines a set of notches 244 that extends from an outer surface 243 of the blanked portion 230 and into the first guide rod 206A orthogonally to the longitudinal axis of the first guide rod 206A. As described later herein, the set of notches 244 are sized and configured to receive a tool (e.g, an open-ended wrench and tools of the like) for further tightening and/or loosening the first guide rod 206A to the base plate 10. The threaded portion 246 of the first guide rod 206A extends from the blanked portion 242 to the rear end 240B of the first guide rod 206A. The threaded portion 246 is sized and configured to operably engage with one of the threaded opening in the set of threaded openings 40 on the base plate 10. In other words, the threaded portion 246 operably threads to one of the threaded opening in the set of threaded openings 40 on the base plate 10. Such engagement between the guide rods 206A, 206B and the set of threaded openings 40A, 40B, 40C, and 40D is described in more detail below.

The first guide rod 206A also defines a threaded chamber 248 that extends from the first end 240A towards the second end 240B relative to the longitudinal axis of the first guide rod 206A. The threaded chamber 248 is sized and configured to receive one of the locking knobs 22A, 22B for further tightening or loosening the first guide rod 206A from the base plate 10. In other words, one of the locking knobs 22A, 22B may operably thread to the threaded chamber 248 of the first guide rod 206A for further tightening or loosening the first guide rod 206A from the base plate 10. Such engagement between the guide rods 206A, 206B and the locking knobs 22A, 22B is described in more detail below.

While not illustrated herein, the first guide rod 206A and the second guide rod 206B may be operably engaged with respective extension rods that further expand the length of the fence assembly 200 for various types of workpiece. In one exemplary embodiment, a woodworker may operably engage at least one additional guide rod described and illustrated herein (such as guide rod 206A) with the guide rod operably engaged with a base plate to further expand the length of a fence assembly for various types of workpiece.

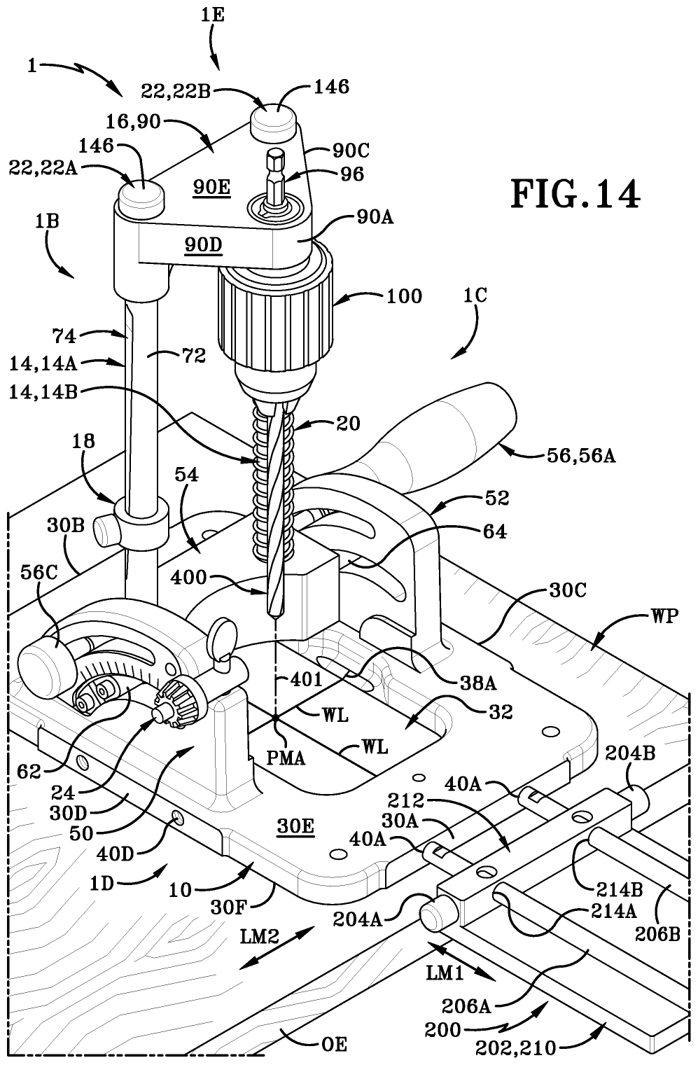

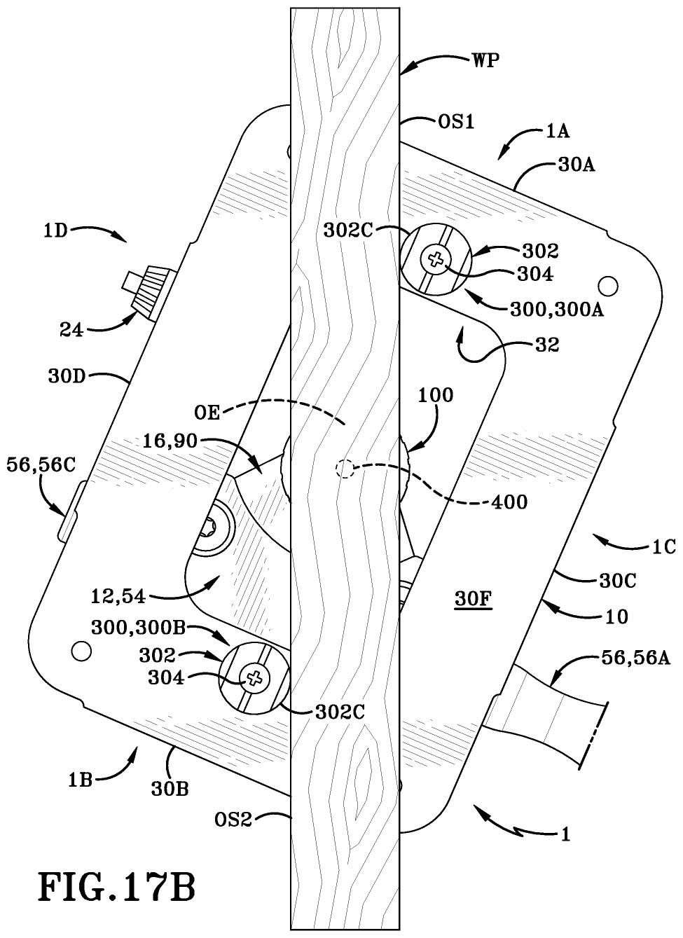

FIGS. 13 and 17A illustrates at least one button stop or centering stop 300 that operably engages with the base plate 10 of the drill guide 1, which is described in more detail below. In the illustrated embodiment a first button stop 300A may operably engage with the base plate 10 via the first threaded vertical passageway 44A, and a second button stop 300B may operably engage with the base plate 10 via the second threaded vertical passageway 44B. The first and second button stops 300A, 300B are substantially similar to one another and operably engage with the base plate 10 in the same orientation. Inasmuch as the first button stop 300A and the second button stop 300B are substantially similar to one another, the following description will relate to the first button stop 300A. It should be understood, however, that the description of the first button stop 300A applies substantially equal to the second button stop 300B.

Referring to FIG. 13, the first button stop 300A includes a bench dog 302. The bench dog 302 defines a first or top end 302A, a second or bottom end 302B opposite to the top end 302A, and a circumferential wall 302C that extends between the top end 302A and the bottom end 302B. The bench dog 302 defines a V-shaped groove 302D that extends into the bench dog 302 from the top end 302A towards the bottom end 302B. The V-shaped groove 302D is configured to enable the bench dog 302 to hold and secure a rounded or curvilinear-shaped workpiece (e.g., a dowel, rod, etc.) when a drill press is drilling a hole into the curvilinear-shaped workpiece. The bench dog 302 also defines a through-hole 302E that extends from V-shaped groove 302D to the bottom end 302B of the bench dog 302. The through-hole 302E is sized and configured to receive a connector 304 of the first button stop 300A. The connector 304 is configured to threadably engage the bench dog 302 with the base plate 10 via one of the first threaded vertical passageway 44A and the second threaded vertical passageway 44B (see FIG. 17A). Such operation of the at least one button stop 300 is described in more detail below.

Having described the structure of the drill guide 1 and the various components and assembles thereof, methods of use thereof will now be described.

Prior to using the drill guide 1 on a workpiece, a drilling bit must be provided on the drill guide 1. As illustrated in FIG. 14, a woodworker may install a drilling bit 400 into the drill chuck 100 of the chuck carrier 16. The drilling bit 400 may also define a longitudinal axis 401 along the entire length of the drilling bit 400. In this configuration, the woodworker may select a drilling bit 400 that is equal to or less than two and one-half inches in diameter. The woodworker using the drill guide 1 would first unlock the drill chuck 100 via the drill chuck key 24. Once unlocked, the woodworker may then apply a rotational force on the drill chuck 100 to expanded the chucks of the drill chuck 100 away from one another to define a suitable diameter that is complementary to the diameter of the drilling bit 400. Once the drilling bit 400 is inserted into the drill chuck 100, the woodworker then applies an opposing rotational force on the drill chuck 100 to collapse the chucks of the drill chuck 100 towards one another to hold and maintain the drilling bit 400 with the drill chuck 100. The woodworker may then finally lock the drill chuck 100 via the drill chuck key 24.

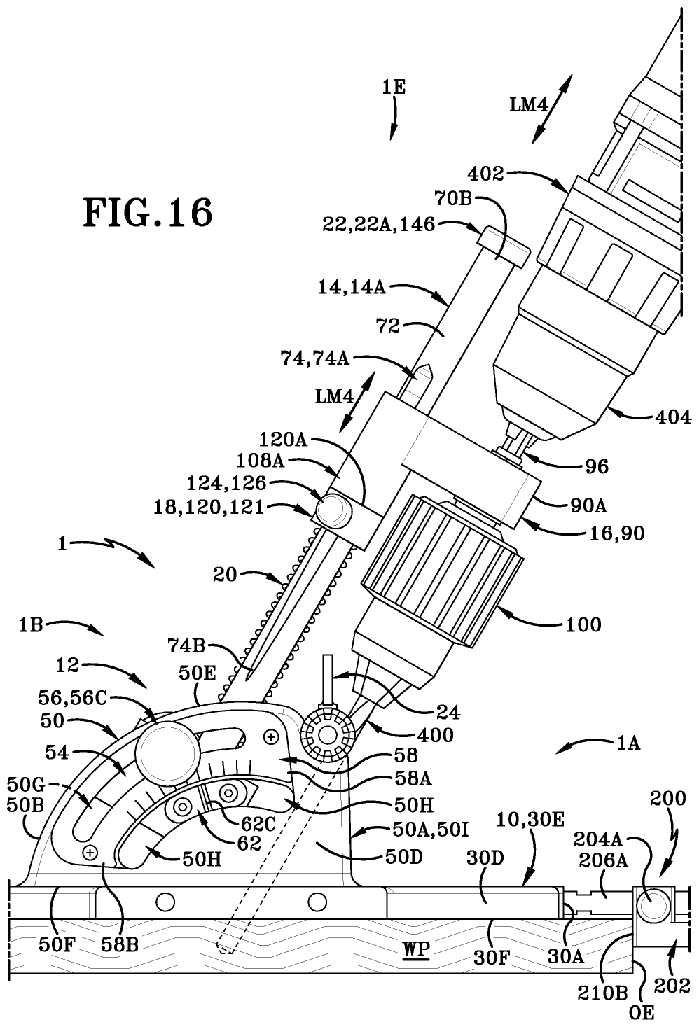

Prior to using the drill guide 1 on a workpiece, the woodworker may then select a suitable depth limit when plunging the drilling bit 400 into a workpiece via the depth stopper 18. Referring to FIG. 15, the woodworker may linearly move the depth stopper 18 along the tapered portion 74 of the first guide column 14A until the woodworker determines a suitable height for limiting the movement of the chuck carrier 16 and the plunging action of the drilling bit 400. The linear movement of the depth stopper 18 is denoted by arrows labeled “A”. During linear movement of the depth stopper 18, the fastener 124 is disengaged from the tapered portion 74 of the first guide column 14A to allow the collar 120 to freely move along the first guide column 14A. Once the woodworker finds a suitable height for limiting the travel of the chuck carrier 16 and the plunging action of the drilling bit 400, the woodworker tightens the fastener 124 against the tapered portion 74 of the first guide column 14A to maintain the desired height of the depth stopper 18.

Prior to using the drill guide 1 on a workpiece, the woodworker may utilize the fence assembly 200 during a drilling operation. The woodworker may operably engage at least one guide rod 206 to the base plate 10. As illustrated in FIG. 14, the woodworker may operably engage a first guide rod 206A and a second guide rod 206B to the base plate 10 via the set of threaded openings 40. In the illustrated embodiment, the first guide rod 206A and the second guide rod 206B operably thread into the first set of threaded openings 40A that is defined at the front end 30A of the base plate 10 via the woodworker apply a rotational force on each of the first guide rod 206A and the second guide rod 206B in the clockwise direction. In other exemplary embodiments, the woodworker may operably thread the first guide rod 206A and the second guide rod 206B into the second set of threaded openings 40B that is defined at the rear end 30B of the base plate 10, operably thread the first guide rod 206A and the second guide rod 206B into the third set of threaded openings 40C that is defined at the left side 30C of the base plate 10, or operably thread the first guide rod 206A and the second guide rod 206B into the fourth set of threaded openings 40D that is defined at the right side 30D of the base plate 10.

To further tighten the first guide rod 206A and the second guide rod 206B into the first set of threaded openings 40A, the woodworker may remove one of the locking knobs 22A, 22B from one of the guide columns 14A, 14B by applying a rotational force on one of the locking knobs 22A, 22B in a counter-clockwise direction. Once one of the locking knobs 22A, 22B is removed from one of the guide columns 14A, 14B, the woodworker may then insert the key portion 144 of the locking knob 22 into the threaded chamber 248 of the first guide rod 206A due to the key portion 144 and the threaded chamber 248 being complementary to one another. Once the locking knob 22 operably engages the first guide rod 206A, the woodworker may apply a rotational force to the locking knob 22 in the clockwise direction to further tighten the first guide rod 206A into one of the threaded openings 40A provided on the front end 30A of the base plate 10. The woodworker may repeat the same tightening process to the second guide rod 206B. Once tightening of the first guide rod 206A and the second guide rod 206B are complete, the woodworker may operably engage the locking knob 22 back into the respective guide column 14A, 14B by applying a rotational force to the locking knob 22 in a clockwise direction until the locking knob 22 is secured inside of the respective guide column 14. The woodworker may also use a tool (e.g., open-ended wrench) to further tighten the first guide rod 206A and the second guide rod 206B into the first set of threaded openings 40A via the notches 246 on each of the first guide rode 206A and the second guide rod 206B.

Optionally, the woodworker may omit the action of setting the depth stopper 18 at a desired height relative to the base plate 10 if desired. Optionally, the woodworker may omit the fence assembly 200 from the drill guide 1 during a drilling operation if desired.

Prior to introducing the drill guide to a workpiece “WP”, the woodworker scribes at least one witness line “WL” at a desired location on the workpiece “WP” to locate the exact point for drilling a hole into the workpiece “WP.” In the illustrated embodiment, a pair of witness lines “WL” is scribed on the workpiece “WP” defining a pivoting movement axis point “PMA” for the drill guide 1, which is described in more detail below. Once the witness line “WL” is scribed on the workpiece “WP,” the woodworker may then introduce the drill guide 1 to the workpiece “WP” and align the drill guide 1 with the set of witness lines “WL” on the workpiece “WP.” The woodworker aligns the drill guide 1 with the set of witness lines “WL” by aligning the guide markers 38A, 38B of the base plate 10 with the witness line “WL.” Once aligned, the longitudinal axis 401 of the drilling bit 400 provided on the drill guide 1 is disposed directly above the pivoting movement axis point “PMA” for drilling a hole into the workpiece “WP.”

Once the drill guide 1 and the drilling bit 400 are suitably aligned with the witness line “WL” and above the pivoting movement axis point “PMA”, the woodworker may then complete assembly of the fence assembly 200. As illustrated in FIG. 14, the woodworker may introduce the fence 202 to the first guide rod 206A and the second guide rod 206B in a first orientation relative to the base plate 10 by inserting the first guide rod 206A and the second guide rod 206B into one of the first set of passageways 214A and the second set of passageways 214B. Prior to engaging the fence 202 with the first and second guide rods 206A, 206B, the first and second thumb screws 204A, 204B are loosened from the fence 202 until the shafts 220 of the first and second thumbs screws 204A, 204B are completely disposed inside of the respective threaded passageway of the set of passageways 216 and away from the respective passageway of the first set of passageways 214A. As such, the woodworker may apply a rotational force on the knobs 226 of the first and second thumb screws 204A, 204B in a counter-clockwise direction to loosen the first and second thumbs screws 204A, 204B from the fence 202. The woodworker may then introduce the fence 202 to the first and second guide rods 206A, 206B once the first and second thumb screws 204A, 204B are provided in a suitable position where the shafts 220 of the first and second thumbs screws are completely disposed inside of the respective threaded passageway of the set of passageways 216 and away from the respective passageway of the first set of passageways 214A.

Still referring to FIG. 14, the woodworker inserts the first guide rod 206A and the second guide rod 206B through the first set of passageways 214A to operably engage the fence 202 to the base plate 10 in the first orientation. The woodworker linearly slides the fence 202 along the first guide rod 206A and the second guide rod 206B until the rear end 210B, 212B of the fence 202 directly abuts against an outermost end “OE” of the workpiece “WP”. The linear movement of the fence 202 along the first guide rod 206A and the second guide rod 206B is denoted by a double arrow labeled “LM1” in FIG. 14. The woodworker may the apply a rotational force on the knobs 226 of the first and second thumb screws 204A, 204B in a clockwise direction to tighten the first and second thumbs screws 204A, 204B to the fence 202 and the first and second guide rods 206A, 206B to maintain the position of the fence 202 on the first and second guide rods 206A, 206B. As such, the first the second thumb screws 204A, 204B prevent linear movement of the fence 202 along the first and second guide rods 206A, 206B during the drilling operation. Furthermore, the woodworker may select the first orientation for the fence 202 in order to maximize the distance of the fence 202 relative to the drilling bit 400 when provided on the first and second guide rods 206A, 206B.

While not illustrated herein, a woodworker may move the drill guide 1 along the workpiece “WP” while still maintaining the desired distance between the witness lines “WL” and the outermost end “OE” of the workpiece “WP” via the fence assembly 200. Such linear movement of the drill guide 1 along the workpiece “WP” is denoted by a double arrow labeled “LM2” in FIG. 14.

While not illustrated herein, a woodworker may use extension rods to expand the distance of the fence 202 relative to the drilling bit 400 for a substantially larger workpiece that the workpiece “WP” illustrated herein. In one exemplary embodiment, a woodworker may install a set of extensions rods to a set of guide rods for maximizing the distance of a fence relative to a base plate at distance from about six and one-half inches up to about twelve inches. In another exemplary embodiment, a woodworker may install more than one set of extensions to a set of guide rods for maximizing the distance of a fence relative to a base plate at a distance up to about twelve inches per set of extension rods used during a drilling operation.

As illustrated in FIG. 14, the first and second top surfaces 210E, 212E of the fence 202 face in the same direction of the top surface 30E of the base plate 10 relative to the longitudinal axis “X” of the drill guide 1. In addition, the fence 202 is positioned away from the base plate 10 at a distance that is measured from the drilling bit 400 to the rear end 210B of the fence 202. In the illustrated orientation, the maximum distance between the front end 30A of the base plate 10 to the rear end 210B of the fence 202 is of about seven and three-quarter inches.

Referring to FIG. 15, the woodworker may then pivot the drill guide 1 to a desired angle via the pivot assembly 12. During a woodworking project, the woodworker applies a rotational force on the handle 56A of the adjustment assembly 56 to loosen the adjustment assembly 56 from the first and second upright supports 50, 52. In this operation, the woodworker loosens the handle 56A and the shaft 56B from the guide member 56C until the handle 56A and the guide member 56C are free from contacting the outer surfaces 50D, 52D of the first and second upright supports 50, 52. Once the handle 56A and the guide member 56C are loosened from the first and second upright supports 50, 52, the woodworker is enabled to pivot portions of the drill guide 1 to set the drilling bit 400 to a suitable angle relative to the base plate 10. More particularly, the woodworker is enable to collectively pivot the pivot block 54, the adjustment assembly 56, and the bearings 62, 64 relative to the first and second upright support 50, 52 and to the pivoting movement axis “PMA” in FIG. 15. Such pivoting of these components of the pivot assembly 12 also collectively pivots the first and second guide columns 14A, 14B, the chuck carrier 16, the depth stopper 18, the biaser 20, and the drilling bit 400 relative to the first and second upright support 50, 52 and the pivoting movement axis “PMA” in FIG. 15.

During this pivoting movement, the handle 56A and the guide member 56C are configured to guide and direct the pivoting movement along the first and second upright supports 50, 52 via the upper slots 50G, 52G. In other words, the handle 56A and the guide member 56C are configured to ride along the first and second upright supports 50, 52 inside of the upper slots 50G, 52G defined by the first and second upright supports 50, 52. Such pivoting movement of the drill guide 1 by the pivot assembly 12 is denoted by a double arrow labeled “PM” in FIG. 15. During this pivoting movement, the first bearing 62 and the second bearing 64 are also configured to guide and direct the pivoting movement along the first and second upright supports 50, 52 via the lower slots 50H, 52H. In other words, the first bearing 62 and the second bearing 64 are configured to ride along the first and second upright supports 50, 52 inside of the lower slots 50H, 52H defined by the first and second upright supports 50, 52.

The woodworker may cease pivoting of the drill guide 1 once the woodworker reaches the desired angle by referencing the protractors 59, 59 and the bearings 62, 64. As illustrated in FIG. 15, the woodworker references the second protractor 59 and the second bearing 64 for precisely and accurately choosing the desired angle. Here, the woodworker selects the desired angle by aligning the indicator 64C of the second bearing 64 with one of the indicia of the set of indicia 59D provided on the second protractor 59 that indicates the desired angle. While not illustrated herein, the woodworker may also reference the first protractor 58 and the first bearing 62 for precisely and accurately choosing the desired angle. Similarly, the woodworker would select the desired angle by aligning the indicator 62C of the first bearing 62 with one of the indicia of the set of indicia 58D provided on the first protractor 58 that indicates the desired angle. Once the woodworker selects the desired angle, the drilling bit 400 is also set at the desired angle for drilling an angled holed in the workpiece “WP”.

Once the indicator 64C is aligned with the indicia of the set of indicia 59D indicating the desired angle, the woodworker may then tighten the adjustment assembly 56 against the first and second upright supports 50, 52 to maintain drill guide 1 at the desired angle. As such, the woodworker applies a second rotational force on the adjustment assembly 56 to tighten the adjustment assembly 56 against the first and second upright supports 50, 52. The woodworker may continue to apply the second rotational force on the adjustment assembly 56 until the adjustment assembly 56 maintains the drill guide 1 at the desired angle. As such, the handle 56A directly abuts the outer surface 50D of the first upright support 50 and the guide member 56C directly abuts the outer surface 52D of the second upright support 52 to tightly fasten the adjustment assembly 56 with the first and second upright supports 50, 52.

During the pivoting movement, the woodworker may be prevented from further rotating the drill guide 1 due to various components of the drill guide 1. In one instance, adjustment assembly 56 of the pivot assemblyl2 may restrict further pivoting movement of the drill guide 1 once the shaft 56B of the adjustment assembly 56 contacts the first and second upright supports 50, 52 proximate to the front ends 50A, 52A inside of the upper slots 50G, 52G. In another instance, the bearings 62, 64 of the pivot assembly 12 may also restrict further pivoting movement of the drill guide 1 once the shaft 56B of the bearings 62, 64 contacts the first and second upright supports 50, 52 proximate to the front ends 50A, 52A inside of the lower slots 50H, 52H. In another instance, the protrusion 50K, 52K may prevent further pivoting movement of the of the drill guide 1 by preventing further rotation of the pivot block 54 towards the base plate 10.

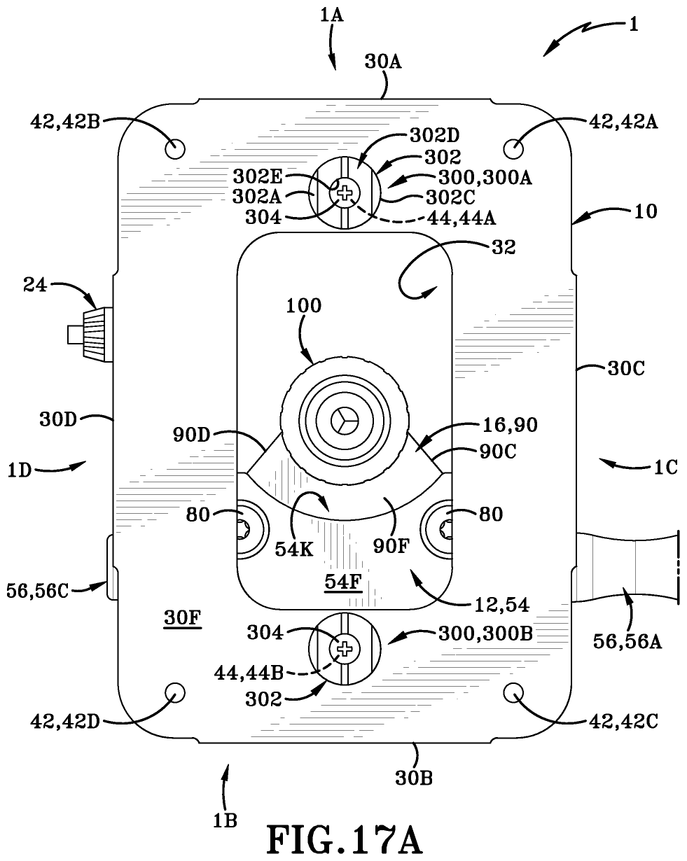

Referring to FIG. 16, the woodworker may then introduce a portable power drill 402 to the drill guide 1 once the drill guide 1 is provided at the desired position on the workpiece “WP”. Any and all hand drills, handheld drills, electric and battery-operated portable power drills contemplated for use with the drill guide disclosed herein will be referred to hereafter throughout this disclosure by the term “portable drill”.

In the illustrated embodiment, the portable power drill 402 includes a drill chuck 404 that may operably engage with the hex bit 96 of the chuck carrier 16 of the drill guide 1. As shown in FIG. 16, the woodworker linearly moves the drill chuck 404 of the portable power drill 402 to the chuck carrier 16 to operably engage the drill chuck 404 with the hex portion 98A of the hex bit 96. The linear movement exerted by the woodworker on the portable power drill 402 is denoted by an arrow labeled “LM3.” Any suitable drill chuck provided on portable power drills may be operably engaged to the hex bit 96 of the drill guide 1. Examples of suitable drill chucks provided on portable power drills include keyed drill chucks, keyless drill chucks, quick release chucks, and any other suitable drill chucks provided on portable power drills. Once the diameters of the drill chuck 404 and the hex bit 96 are complementary to one another, the woodworker engages the drill chuck 404 to the hex bit 96 by locking the drill chuck 404 to the hex bit 96.

Once the portable power drill 402 is operably engaged to the drill guide 1, the woodworker may drill a hole into the workpiece “WP.” As illustrated in FIG. 16, the woodworker applies a downward linear force on the portable power drill 402 directed towards the base plate 10 to linear move both the portable drill 402 and the chuck carrier 16. Such linear movement of both the portable drill 402 and the chuck carrier 16 towards the base plate 10 is denoted by double arrows labeled “LM4” in FIG. 16. As the woodworker applies the downward force to the portable power drill 402, the chuck carrier 16 and associated parts on the chuck carrier 16 progress towards the base plate 10 and the workpiece “WP.” During this downward linear force, the portable power tool 402 is also applying a rotational force to the hex bit 96, via the woodworker activating the power of the portable power drill 402, which transfers to the drill chuck 100 of the chuck carrier 16. Since the drill chuck 100 of the chuck carrier 16 is rotating, the drilling bit 400 operably engaged to the drill chuck 100 is also rotating with the drill chuck 100 via the rotational force created by the portable power drill 402. As the drilling bit 400 plunges into the workpiece “WP,” the woodworker may plunge the drilling bit 400 into the workpiece “WP” until the first protrusion 108A directly abuts and/or hits the depth stopper 18 while plunging the drilling bit 400. Since the tapered portion 74 gradually increases towards the bottom end 70B of the first guide column 14A, the fastener 124 is pressed against the tapered portion 74 causing a self-tightening interaction for preventing the depth stopper 18 from moving downwardly towards the base plate 10. As such, a sudden hit or strike on the depth stopper 18 by the chuck carrier 16 will not move the depth stopper 18 downwardly due to the interaction between the tapered portion 74 of the first guide column 14A and the fastener 124 of the depth stopper 18.

Once the woodworker has completed the drilling process and drilled a hole “H” into the workpiece “WP,” the biaser 20 provides assistance to the woodworker for moving the chuck carrier 16 and the portable power drill 402 after performing a drilling operation (see FIG. 16). Here, the biaser 20 assists the woodworker by applying an upward linear force on the chuck carrier 16 and the portable power drill 402 that is directed away from the base plate 10 and away from the workpiece “WP” to move the drilling bit 400 from the workpiece “WP.” In addition, the woodworker may repeat the plunging process and removal process illustrated in FIG. 16 until a desired hole is drilled into and/or through the workpiece “WP.”

As described below, the fence assembly 200 provides multiple orientations for allowing the woodworker to drill into a workpiece with different orientations of the fence 202 and different attachment points of the guide rods 206 to the base plate 10.

In one instance, the woodworker may orient the fence 202 on the first and second guide rods 206A, 206B in a second orientation relative to the base plate 10. In the second orientation, the first and second top surfaces 210E, 212E of the fence 202 face an opposing direction as compared to the top surface 30E of the base plate 10 relative to the longitudinal axis “X” of the drill guide 1. Similar to the first orientation as illustrated in FIG. 14, the first and second guide rods 206A, 206B operably engage with the fence 202 via the first set of passageways 214A. In this instance, the second top surface 212A of the step 212 operably engages with a top surface of a workpiece. In this orientation, the fence 202 provides the woodworker with additional support and stability when using the drill guide 1 to drill a hole into the workpiece. In other words, the fence 202 acts an outrigger that provides the woodworker with additional support and stability when using the drill guide 1 to drill a hole into the workpiece.

Generally, a woodworker would desire this second orientation of the fence 200 when the woodworker is drilling a hole into a substantially large workpiece where additional stability is needed to maintain the position and alignment of the drill guide 1 over a drilling location. During a drilling operation, the woodworker would apply a downward linear force onto the bottom surface 210F of the fence 202 to provide additional support and stability to the drill guide 1 in which the step 212 would act as a cleat or support member. In addition, the fence 202 is positioned away from the base plate 10 at a distance that is measured from the drilling bit 400 to the rear end 210B of the fence 202. In the illustrated orientation, the maximum distance between the front end 30A of the base plate 10 to the rear end 2106 of the fence 202 is up to about six and one-half inches.

In another instance, the woodworker may orient the fence 202 on the first and second guide rods 206A, 206B in a third orientation relative to the base plate 10. In the third orientation, the first and second top surfaces 210E, 212E of the fence 202 face in the same direction as the top surface 30E of the base plate 10 relative to the longitudinal axis “X” of the drill guide 1. Similar to the first orientation as illustrated in FIG. 14, the first and second guide rods 206A, 206B operably engage with the fence 202 via the first set of passageways 214A. However, the first and second guide rods 206A, 206B enter the fence 200 from front end 210A and exit at the rear end 210B. In the third orientation, the front end 210A of the fence 202 operably engages with an outermost end of a workpiece for maintaining a distance between the fence 202 and the drilling bit 400. In addition, a portion of the fence 202 measured from the front end 210A towards the rear end 210B is disposed beneath the base plate 10 where the first top surface 210A of the fence 202 is adjacent to and faces the bottom surface 30F of the base plate 10.

Generally, a woodworker would select the third orientation for the fence 202 to minimize the distance between the drilling bit 400 and the fence 202 when drilling a hole proximate to an outermost end of the workpiece. During a drilling operation, the woodworker would operably engage the fence 202 to the first and second guide rods 206A, 206B by orienting the front end 210A of the fence 202 at the front end 30A of the base 10 and having the first and second guide rods 206A, 206A enter through the front end 212A of the step 212 and exit at the rear end 212B of step 212. The third orientation of the fence 202 allows the woodworker to have support and stability when drilling holes close to the outermost end of a workpiece. As a woodworker moves the drill guide 1 closer to the outermost end of the workpiece, the woodworker will also move the front end 210A of the fence 202 closer to the drilling bit 400 to compensate for the overhang and/or unsupported base plate 10 when resting on the workpiece. As such, the third orientation of the fence 202 acts as a cantilever in which the front end 210A of the fence 200 directly abuts the outermost end of the workpiece while providing horizontal support to the drill guide 1 during a drilling operation. When the fence 202 is provided in the third orientation, the woodworker may drill a hole into the workpiece at a distance measured from the drilling bit 400 to the front end 210E of the fence 200. In the illustrated orientation, a hole may be drilled into a workpiece that is about one-half of an inch away from an outermost end of the workpiece.

In yet another instance, the woodworker may orient the fence 202 on the first and second guide rods 206A, 206B in a fourth orientation relative to the base plate 10. In the fourth orientation, the first and second top surfaces 210E, 212E of the fence 202 are substantially orthogonal to the top surface 30E of the base plate 10 relative to the longitudinal axis “X” of the drill guide 1. In the fourth orientation, the first and second guide rods 206A, 206B operably engaged with the fence 202 via the second set of passageways 214B as compared to the first, second, and third orientations of the fence 202. Here, first and second guide rods 206A, 206B enter the fence 200 at the bottom end 210F and exit at the second upper surface 212E of the step 212. In the fourth orientation, the bottom surface 210F of the fence 202 operably engages with an outermost end of a workpiece for maintaining a distance between the fence 202 and the drilling bit 400.

Generally, a woodworker would desire the fourth orientation of the fence 200 when the woodworker is drilling a hole into a substantially vertical workpiece and needs additional horizontal support at a distance above the drill guide 1. During a drilling operation, the woodworker would operably engage the fence 202 to the first and second guide rods 206A, 206B by orienting the bottom surface 210F of the fence 202 at the front end 30A of the base 10 and having the first and second guide rods 206A, 206A enter through the bottom surface 210F of the fence 200 and exit at the second upper surface 212E of step 212. The fourth orientation of the fence 202 allows the woodworker to have horizontal support and stability at an outermost end of a workpiece when drilling holes into a workpiece that is vertically-oriented. When drilling a hole into the workpiece, the woodworker may apply a downward linear force onto the first top surface 210E and/or the second upper surface 212E of the fence 202 to maintain the position of the drill guide 1 on the vertically-oriented workpiece.

Referring to FIGS. 17A and 17B, the woodworker may operably engage the first and second button stops 300A, 300B with the first and second threaded vertical passageways 44A, 44B of the base 10. As illustrated in FIG. 17A, the woodworker may align the bench dog 302 of the first button stop 300A with the first threaded vertical passageway 44A. Once aligned, the woodworker may then pass the connector 304 through the bench dog 302, via the through-hole 302E, and threadably engage the connector 304 with the first threaded vertical passageway 44A. Such engagement between the connector 304 and the first threaded vertical passageway 44A operably engages the bench dog 302 of the first button stop 300A with the base plate 10. Similarly, the woodworker may operably engage the second button stop 300B with the base plate 10 via the second threaded vertical passageway 44B.

Once the first and second button stops 300A, 300B are operably engaged with the base plate 10, the woodworker may introduce the drill guide 1 to various types of workpiece for drilling operations. As illustrated in FIG. 17B, the drill guide 1 is introduced to another workpiece “WP” in which the first and second button stops 300A, 300B are operably engaged with the workpiece “WP.” Upon engagement, the bench dog 302 of the first button stop 300A operably engages with a first outermost side “OS1” of the workpiece “WP”. Specifically, the circumferential wall 302C of the bench dog 302 of the first button stop 300A operably engages with the first outermost side “OS1” of the workpiece “WP”. Similarly, the bench dog 302 of the second button stop 300B operably engages with a second outermost side “OS2” of the workpiece “WP” where the second outermost side “OS2” is opposite to the first outermost side “OS1”. Specifically, the circumferential wall 302C of the bench dog 302 of the second button stop 300B operably engages with the second outermost side “OS2” of the workpiece “WP”. Such engagement between the first and second button stops 300A, 300B and the workpiece “WP” enables the drill guide 1 to maintain the workpiece “WP” with the drill guide 1 during drilling operation.

Once the bench dogs 302 of the first and second button stops 300A, 300B operably engages with the workpiece “WP”, the woodworker may then drill at least one hole into the workpiece “WP”. In one instance, the woodworker may drill at least one hole that is substantially vertical and/or orthogonal to the workpiece “WP”. In another instance, the woodworker may drill at least one hole at an angle relative to the workpiece “WP” via operation of the pivot assembly 12 as described above.

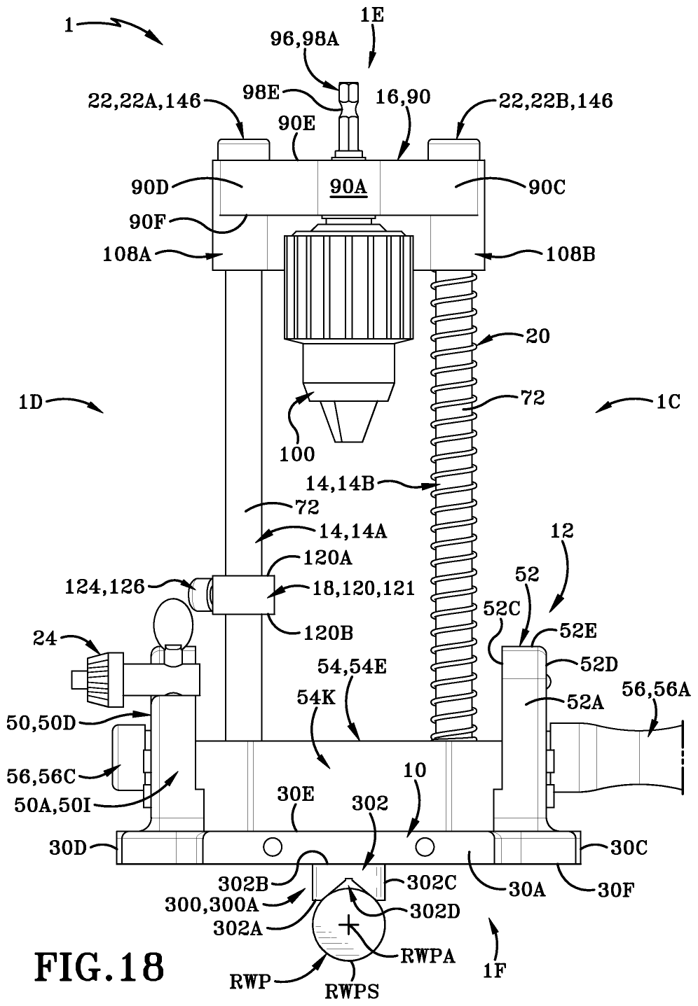

Referring to FIG. 18, a rounded and/or curvilinear workpiece “RWP” may be operably engaged with the first and second button stops 300A, 300B to allow the drill guide 1 to drill angled holes into the rounded workpiece “RWP.” In the illustrated embodiment, the rounded workpiece “RWP” defines a longitudinal axis “RWPA” along the entire length of the rounded workpiece “RWP” and a circumferential surface “RWPS” along the entire length of the rounded workpiece “RWP.” During a woodworking project, the bench dogs 302 are configured to receive and support the rounded workpiece “RWP” at different locations on the rounded workpiece “RWP” via the grooves 302D defined in the bench dogs 302. As such, the bench dog 302 of the first button stop 300A operably engages with the circumferential surface “RWPS” of the rounded workpiece “RWP” at a first position on the rounded workpiece “RWP” via the groove 302D defined in the bench dog 302. While not illustrated herein, the bench dog 302 of the second button stop 300B also operably engages with the circumferential surface “RWPS” of the rounded workpiece “RWP” at a second position opposite to the first position on the rounded workpiece “RWP” via the groove 302D defined in the bench dog 302. In one exemplary embodiment, first and second button stops may be operably engaged on a top surface of a base plate where a rounded workpiece is positioned vertically above the base plate during a woodworking project.

In other exemplary embodiments, additional assemblies and/or component may be operably engaged with the drill guide 1 for various woodworking projects. In one example, at least one flip stop may be operably engaged with the illustrated drill guide 1 via at least one fence guide rod 206 or other suitable guide rods that may operably engage with the drill guide; specifically, Woodpecker's Auto Line Drill Guide Flip Stop may be operably engaged with the illustrated drill guide 1 via at least one fence guide rod 206 or other suitable guide rods that may operably engage with the drill guide.

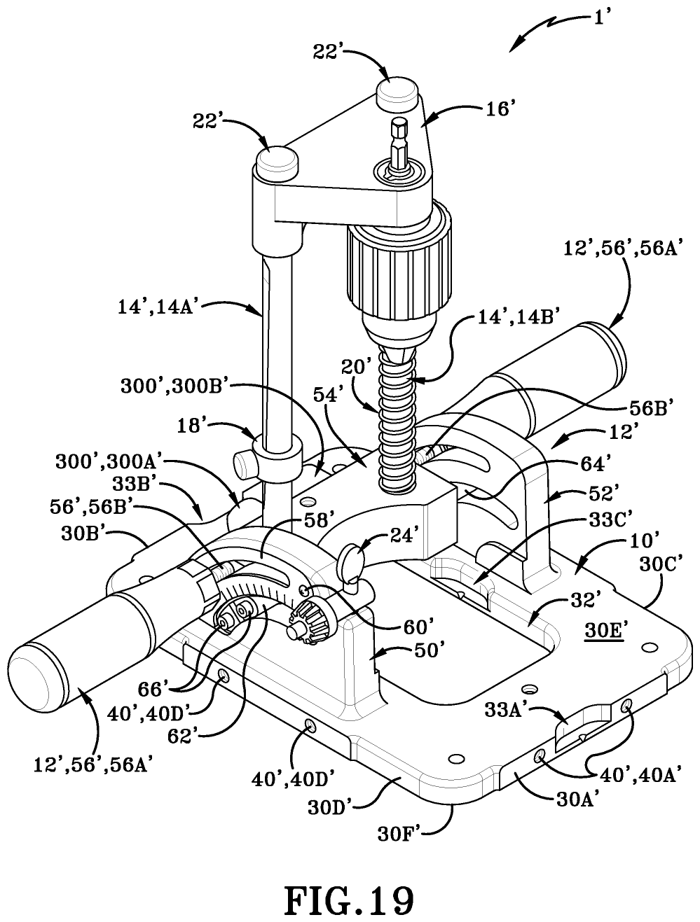

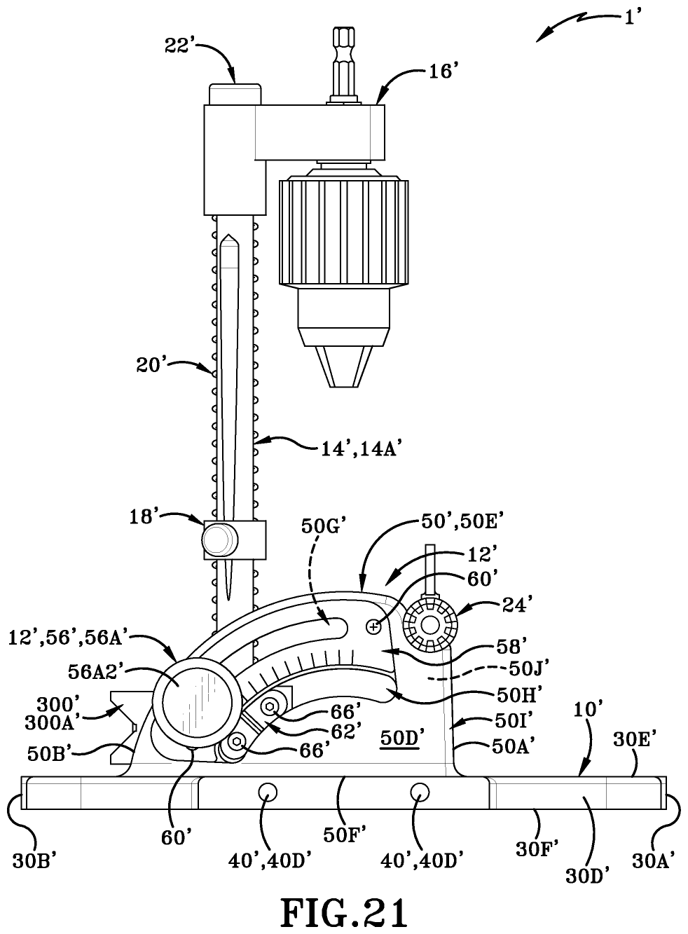

FIGS. 19-25 illustrate a drill guide, generally referred to as 1′, for use with a hand drill or a portable drill, which is described in more detail below. Drill guide 1′ described and illustrated herein is similar to drill guide 1 discussed above and illustrated in FIGS. 1-9, except as detail below. The drill guide 1′ includes a base plate 10′, a pivot assembly 12′, at least one guide column 14′, a chuck carrier 16′, a depth stopper 18′, a biaser 20′, at least one locking knob 22′, a drill chuck key 24′, and a calibration assembly 26′; such components and devices of drill guide 1′ are now described in more detail below.

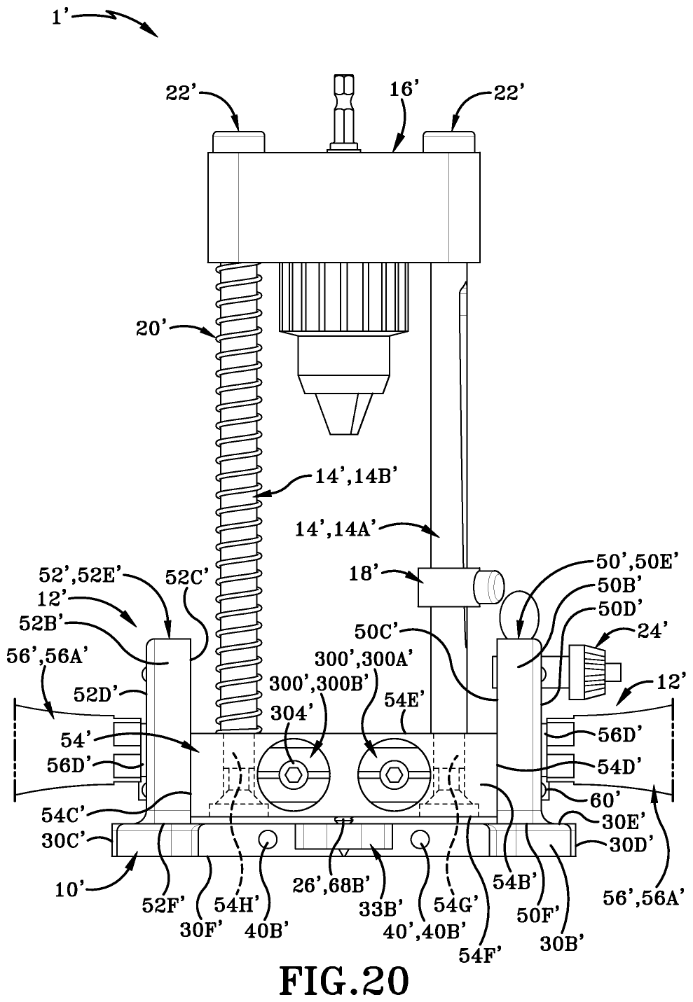

Referring now to FIGS. 19 and 20, the base plate 10′ includes a front end 30A′, a rear end 30B′ that opposes the front end 30A′, and a longitudinal axis extending between the front end 30A′ and the rear end 30B′ where the longitudinal axis of base plate 10′ is aligned with a longitudinal axis “X” of drill guide 1′. The base plate 10′ also includes a left side or first side 30C′, a right side or second side 30D′ that opposes the left side 30C′, and a transverse axis extending between the left side 30C′ and the right side 30D′ where the transverse axis of base plate 10′ is aligned with a transverse axis “Y” of drill guide 1′. The base plate 10′ also includes a top surface 30E′ that is vertically above the first end 30A′, rear end 30B′, the first side 30C′, and the second side 30D′, a bottom surface 30F′ that is vertically below the first end 30A′, rear end 30B′, the first side 30C′, and the second side 30D′ and vertically opposite to the top surface 30E′, and a vertical axis extending between the top surface 30E′ and bottom surface 30F′ and is aligned with a vertical axis “Z” of drill guide 1′.

Referring to FIG. 19, the base plate 10′ defines a central opening 32′ that is disposed between the front end 30A′ and the rear end 30B′ of the base plate 10′ and extends between top surface 30E′ and bottom surface 30F′ of base plate 10′. In the illustrated embodiment, the central opening 32′ defined by the base plate 10′ is curvilinear and/or round in shape substantially similar to central opening 32 of base plate 10 described above. Furthermore, the central opening 32′ may be any suitable shape that will enable different types of drilling bits of different diameters and lengths to be received therethrough, in particular drilling bits up to diameters of one inch.

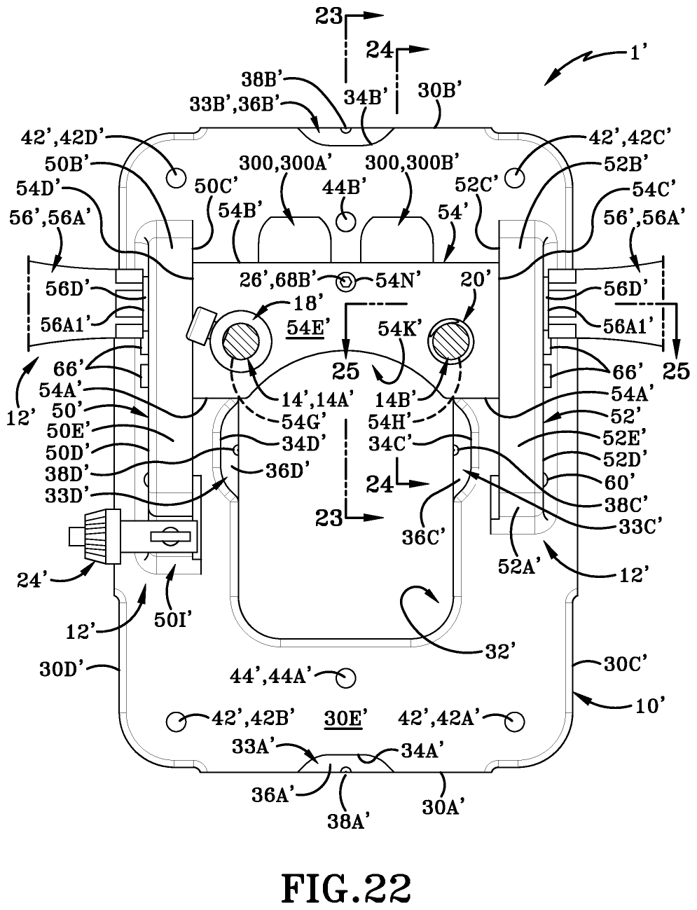

Still referring to FIGS. 19, 20, and 22, the base plate 10′ also defines a set of recesses 33′. In this embodiment, the base plate 10′ defines a first recess 33A′, a second recess 33B′, a third recess 33C′, and a fourth recess 33D′. As best seen in FIG. 22, the first recess 33A′ and the second recess 33B′ are defined exterior to the central opening 32′, and the third recess 33C′ and the fourth recess 33D′ are defined interior to the central opening 32′. With respect to the first recess 33A′ and the second recess 33B′, the first recess 33A′ is defined at the front end 30A′ of the base plate 30′, and the second recess 33B′ is defined at the rear end 30B′ of the base plate 30′. With respect to the third recess 33C′ and the fourth recess 33D′, the third recess 33C′ is defined proximate to the first side 30C′ of the base plate 30′ and between the first and second ends 30A′, 30B′, and the fourth recess 33D′ is defined proximate to the second side 30D′ of the base plate 30′ and between the first and second ends 30A′, 30B′.

Each recess 33A′, 33B′, 33C′, 33D′ formed in base plate 30′ is bounded by a circumferential wall 34A′, 34B′, 34C′, 34D′ extending from the top surface 30E′ to an angled bottom wall 36A′, 36B′, 36C′, 36D′ disposed between the top surface 30E′ and the bottom surface 30F′. As best seen in FIG. 22, first, second, third, and fourth guide markers 38A′, 38B′, 38C′, 38D′ are provided on the angled bottom walls 36A′, 36B′, 36C′, 36D′. As shown in FIG. 22, the first and second guide markers 38A′, 38B′ are aligned with one another parallel with the longitudinal axis of the base plate 10′, and the third and fourth guide marker 38C′, 38D′ are aligned with one another parallel with the transverse axis of the base plate 10′.

During operation, a woodworker may use one or more of the first, second, third, and fourth guide markers 38A′, 38B′, 38C′, 38D′ on the base plate 10′ for accurately positioning the drill guide 1′ with a predetermined drilling location via sets of witness marks scribed on a workpiece (e.g., FIG. 14). In one instance, the first and second markers 38A′, 38B′ on the base plate 10′ allows a woodworker to align the first and second guide markers 38A′, 38B′ of the drill guide 1′ with a set of witness lines scribed on a workpiece for accurately positioning the drill guide 1′ with a predetermined drilling location. In another instance, the third and fourth markers 38C′, 38D′ on the base plate 10′ allows a woodworker to align the third and fourth guide markers 38C′, 38D′ of the drill guide 1′ with a set of witness lines scribed on a workpiece for accurately positioning the drill guide 1′ with a predetermined drilling location. In yet another instance, the first, second, third, and fourth guide markers 38A′, 38B′, 38C′, 38D′ on the base plate 10′ allows a woodworker to align the first, second, third, and fourth guide markers 38A′, 38B′, 38C′, 38D′ of the drill guide 1′ with a set of witness lines scribed on a workpiece for accurately positioning the drill guide 1′ with a predetermined drilling location.

Referring now to FIGS. 19-22, the base plate 10′ defines a set of threaded openings 40′ that extends laterally into the base plate 10′ relative to the longitudinal axis or the transverse axis of the base plate 10′. It should be understood that the set of threaded openings 40′ are substantially similar to the set of threaded openings 40 defined in base plate 10 described above. As such, a first set of threaded openings 40A′, a second set of threaded openings 40B′, a third set of threaded openings (not illustrated), and a fourth set of threaded openings 40D′ are substantially similar to the first set of threaded openings 40A, second set of threaded openings 40B, third set of threaded openings 40C, and fourth set of threaded openings 40D defined in base plate 10 of drill guide 1.

Referring now to FIG. 22, the base plate 10′ defines a set of vertical passageways 42′ having first, second, third, and fourth vertical passageways 42A′, 42B′, 42C′, and 42D′. The first, second, third, and fourth vertical passageways 42A′, 42B′, 42C′, and 42D′ are substantially similar to the first, second, third, and fourth vertical passageways 42A, 42B, 42C, and 42D of the base plate 10 of drill guide 1 described previously. Similar to the set of vertical passageways 42A, 42B, 42C, 42D, the set of vertical passageways 42A′, 42B′, 42C′, 42D′ may be used for various woodworking projects. In one instance, the set of vertical passageways 42A′, 42B′, 42C′, 42D′ may enable a woodworker to introduce connectors (e.g., fasteners and other connectors of the like) to the operably engage the base plate 10′ with a support structure or a workpiece to fix the drill guide 1′ at a desired position on the support structure or workpiece.

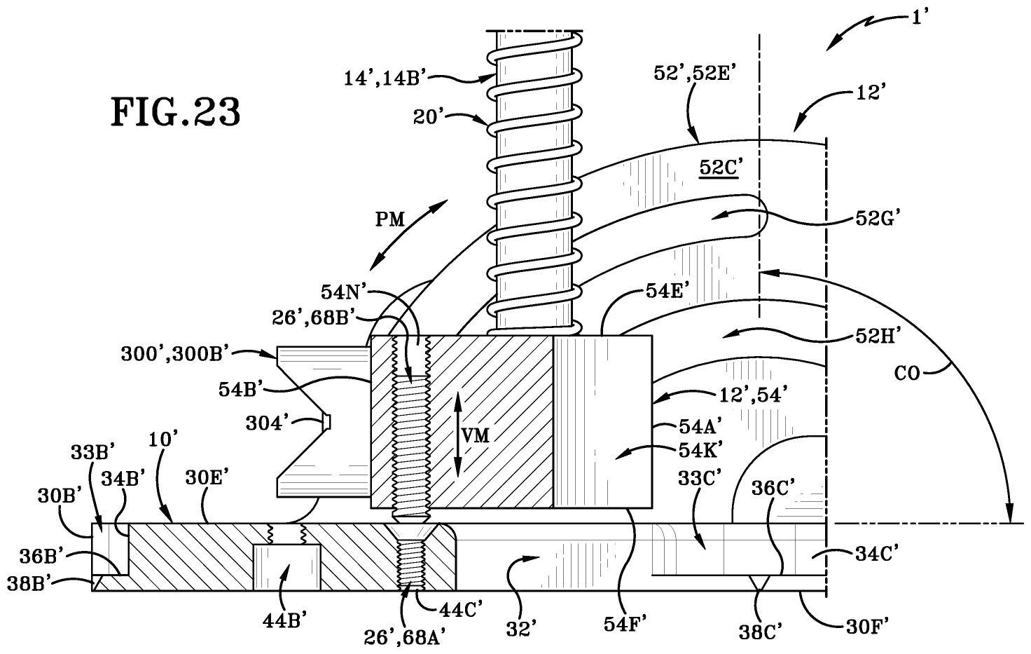

Referring now to FIG. 22, the base plate 10′ defines a set of threaded vertical passageways 44′ having a first threaded vertical passageway 44A′ and a second threaded vertical passageway 44B′. The first and second threaded vertical passageways 44A′, 44B′ are substantially similar to the first and second threaded vertical passageways 44A, 44B described above. Similar to the first and second threaded vertical passageways 44A, 44B, first and second threaded vertical passageways 44A′, 44B′ are configured to receive connectors for components and parts of the drill guide for specific woodworking projects, which is described in more detail below. The set of threaded vertical passageways 44′ also includes a third threaded vertical passageway 44C′. As best seen in FIG. 23, the third threaded vertical passageway 44C′ is defined proximate to the rear end 30B′ and positioned between the second threaded vertical passageway 44B′ and the right side 30D′; such use and purpose of the third threaded vertical passageway 44C′ is defined in more detail below.

The drill guide 1′ also includes the pivot assembly 12′ that operably engages with the base plate 10′. As described in more detail below, portions of the pivot assembly 12′ are selectively moveable relative to the base plate 10′ during woodworking projects. As such, the components of the pivot assembly 12′ will now be described in more detail below.

Referring to FIGS. 19-22, the pivot assembly 12′ includes at least one upright support that operably engages with the base plate 10′. In the illustrated embodiment, the pivot assembly 12′ includes a first upright support 50′ that operably engages with the top surface 30E′ of the base plate 10′ and is positioned proximate to the right side 30D′ of the base plate 10′, and a second upright support 52′ that operably engages with the top surface 30E′ of the base plate 10′ and is positioned proximate to the left side 30C′ of the base plate 10′. It should be understood that first and second upright supports 50′, 52′ are substantially similar to first and second upright supports 50, 52 of the pivot assembly 12 of drill guide 1 discussed above. As such, front ends 50A′, 52A′, rear ends 50B′, 52B′, inner surfaces 50C′, 52C′, outer surfaces 50D′, 52D′, top ends 50E′, 52E′, bottom end 50F′, 52F′, first or upper slots 50G′, 52G′, second or lower slots 50H′, 52H′ are substantially similar to front ends 50A, 52A, rear ends 50B, 52B, inner surfaces 50C, 52C, outer surfaces 50D, 52D, top ends 50E, 52E, bottom end 50F, 52F, first or upper slots 50G, 52G, second or lower slots 50H, 52H′ of pivot assembly 12 of drill guide 1 discussed above. First upright support 50′ also includes a shoulder 501′ and a cavity 50J′ that are substantially similar to shoulder 501 and cavity 50J of the first upright support 50 of pivot assembly 12 of drill guide 1 discussed above.

Referring to FIGS. 19-20 and 22-25, the pivot assembly 12′ includes a pivot block 54′ that operably engages with first and second upright supports 50′, 52′ via at least one adjustment assembly 56′, which is described in more detail below. The pivot block 54′ is also positioned between the first upright support 50′ and the second upright support 52′ and vertically above the base plate 10′. Pivot block 54′ includes a front end 54A′, a rear end 54B′, a left or first side 54C′, a right or second side 54D′, a top surface 54E′, a bottom surface 54F′, a first vertical passageway 54G′, a second vertical passageway 54H′, a set of threaded openings 54J′, and an arcuate notch 54K′ that are substantially similar to front end 54A, rear end 54B, left or first side 54C, right or second side 54D, top surface 54E, bottom surface 54F, first vertical passageway 54G, second vertical passageway 54H, set of threaded openings 54J, and arcuate notch 54K of pivot block 54 of pivot assembly 12 described above, except as detailed below.

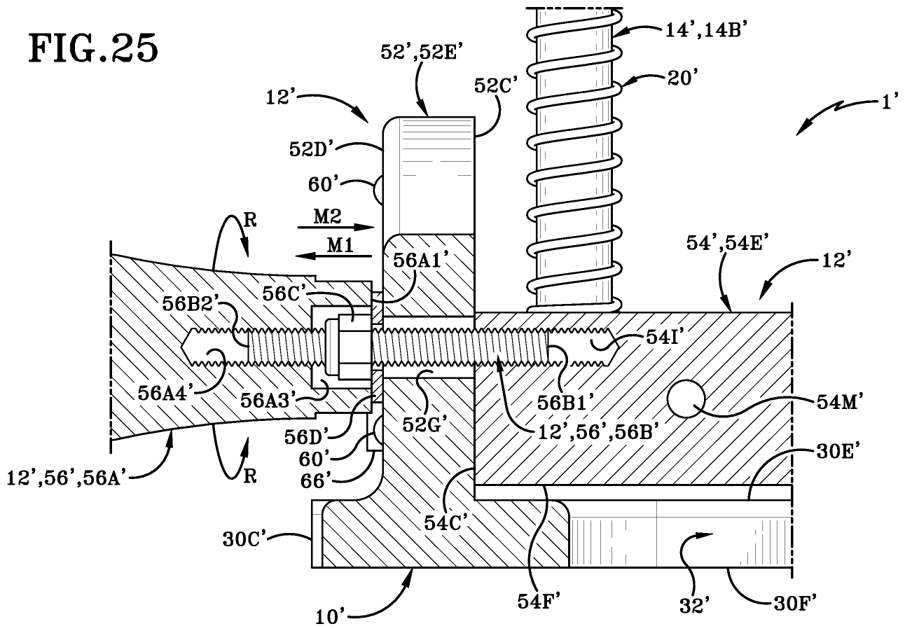

Pivot block 54′ may also include at least one threaded longitudinal chamber 54′. In this illustrated embodiment, pivot block 54′ includes a pair of threaded longitudinal chamber 54I′. A first threaded longitudinal chamber of pair of threaded longitudinal chambers 54I′ extends into the pivot block 54′ along the longitudinal from the first side 54C′ towards the second side 54D′. As best seen in FIG. 25, a second threaded longitudinal chamber of the pair of threaded longitudinal chambers 54I′ also extends into the pivot block 54′ but from the second side 54D′ towards the first side 54C′. In the illustrated embodiment, the first threaded longitudinal chamber and the second threaded longitudinal chamber of the pair of threaded longitudinal chambers 54I′ are spaced apart from one another and are free from being in fluid communication with one another inside of the pivot block 54′. Such use and purpose of the pair of threaded longitudinal chambers 54I′ are described in more detail below. In other exemplary embodiments, any suitable number of threaded longitudinal chambers may be defined in a pivot block based on various considerations, including the shape, size, and configuration of a pivot block.

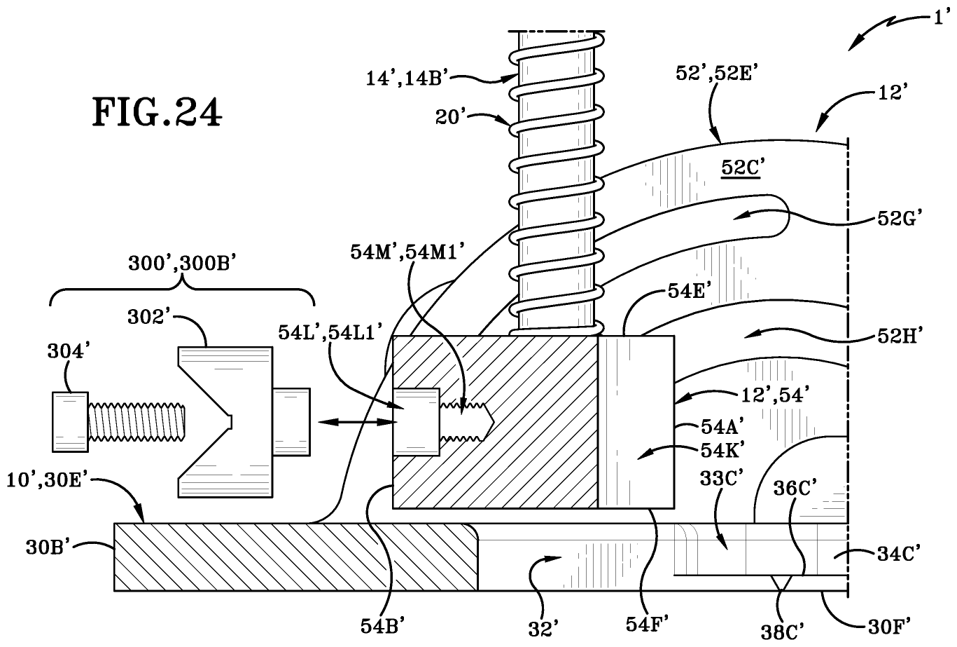

Pivot block 54′ also defines at least one passage 54L′ and at least one threaded pocket 54M′. In this illustrated embodiment, pivot block 54′ defines a pair of passages 54L′ and a pair of threaded pockets 54M′. As best seen in FIG. 24, each passage of the pair of passages 54L′ extends into the pivot block 54′ from the rear end 54B′ towards the front end 54A′ along the longitudinal axis of the pivot block 54′. Still referring to FIG. 24, each threaded pocket of the pair of threaded pockets 54M′ extends from a respective passage of the pair of passages 54L′ towards the front end 54A′. Such uses and purposes of the pair of passages 54L′ and the pair of threaded pockets 54M′ are described in more detail below.

Pivot block 54′ also defines a vertical threaded passageway 54N′. As best seen in FIG. 23, vertical threaded passageway 54N′ extends downwardly into the pivot block 54′ between the top surface 54E′ and the bottom surface 54F′ where the top surface 54E′ and the bottom surface 54F′ are in fluid communication with one another via the vertical threaded passageway 54N′. The vertical threaded passageway 54N′ is also positioned between the first vertical passageway 54G′ and the second vertical passageway 54H′. Such use and purpose of the vertical threaded passageway 54N′ is described in more detail below.

Pivot assembly 12′ also includes an adjustment assembly 56′ that operably engages the pivot block 54′ with the first upright support 50′ and the second upright support 52′. The adjustment assembly 56′ is similar to the adjustment assembly 56 of pivot assembly 12 of drill guide 1 described above, except as detail below.

As best seen in FIGS. 19 and 25, adjustment assembly 56′ includes at least one handle 56A′ that operably engages with at least one threaded shaft 56B′, which is described in more detail below. In this embodiment, the adjustment assembly 56′ includes a pair of handles 56A′ that operably engages with a pair of threaded shafts 56B′. Each handle of the pair of handles 56A′ includes a first end 56A1′, a second end 56A2′ opposite to the first end 56A2′, a passageway 56A3′ extending longitudinally into the handle 56A′ from the first end 56A2′ towards the second end 56A2′ (as best seen in FIG. 25), and a threaded chamber 56A4′ extending longitudinally from the passageway 56A3′. As best seen in FIG. 25, each handle of the pair of handles 56A′ releasably secures with a respective threaded shaft of the pair of threaded shafts 56B′ via the threaded chamber 56A4′ defined inside each handle of the pair of handles 56A′.

As illustrated in FIG. 25, the pair of threaded shafts 56B′ operably engages with the pivot block 54′, via the pair of threaded longitudinal chambers 54I′, such that the pair of threaded shafts 56B′ threadably engages inside of the pivot block 54′. As best seen in FIG. 25, each threaded shaft of the pair of threaded shafts 56B′ includes a first end 56B1′ operably engaged with pivot block 54′ and positioned inside of the pivot block 54′, and a second end 56B2′ opposite to the first end 56B1′ and operably engaged with and positioned inside of a respective handle 56A′.

Adjustment assembly 56′ also includes at least one drag nut 56C′ that threadably engages with the at least one threaded shaft 56B′ and housed inside the passageway 56A3′ of the at least one handle 56A′. In this embodiment, adjustment assembly 56′ also includes a pair of drag nuts 56C′ that threadably engages with the pair of threaded shafts 56B′ and housed inside the passageways 56A3′ of the pair of handles 56A′. As best seen in FIG. 25, each drag nut of the pair of drag nuts 56C′ threadably engages with a respective threaded shaft of the pair of threaded shafts 56B′ to secure the pivot block 54′ with the first upright support 50′ and the second upright support 52′. During operation, the pair of drag nuts 56C′ are configured to provide drag and/or friction against the first and second upright supports 50′, 52′ so that the pivot block 54′, along with the pair of guide columns 14′, the chuck chamber 16′, the stop collar 18′, and the biaser 20′, may be held and maintained at a desired angle until further securement is provided by the handles 56A′.

Adjustment assembly 56′ also includes a pair of washers 56D′ that operably engages with the pair of threaded shafts 56B′ (as seen in FIG. 25). As best seen in FIG. 25, a first washer of the pair of washers 56D′ is engaged with a first threaded shaft of the pair of threaded shafts 56B′ and is positioned between a first drag nut of the pair of drag nuts 56C′ and the outer surface 52D′ of the second upright support 52′. While not illustrated herein, a second washer of the pair of washers 56D′ is engaged with a second threaded shaft of the pair of threaded shafts 56B′ and is positioned between a second drag nut of the pair of drag nuts 56C′ and the outer surface 50D′ of the first upright support 50′. The pair of washers 56D′ enables the pair of drag nuts 56C′ to releasably secure against the outer surfaces 50D′, 52D′ of the first and second upright supports 50′, 52′, via the pair of threaded shafts 56B′, to prevent marring or damaging of the outer surfaces 50D′, 52D′ of the first and second upright supports 50′, 52′ when the pivot block 54′ and the adjustment assembly 56′ move along the first and second upright supports 50′, 52′. Upon assembly, the pair of drag nuts 56C′ are releasably secured against the pair of washers 56D′ and the outer surfaces 50D′, 52D′ of the first and second upright supports 50′, 52′ to a specific torque in which the pivot block 54′ and the adjustment assembly 56′ are pivotable about the first and second upright supports 50′, 52′ yet may be maintained at a desired angle relative to the base plate 10′ prior to further securement by the pair of handles 56A′.

Referring to FIGS. 19 and 20, the pivot assembly 12′ also includes at least one protractor that operably engages with one or both of the first upright support 50′ and the second upright support 52′. In the illustrated embodiment, the pivot assembly 12′ includes a first protractor 58′ that operably engages with the first upright support 50′; more particularly, the first protractor 58′ that operably engages with the outer surface 50D of the first upright support 50′. In the illustrated embodiment, the pivot assembly 12′ also includes a second protractor 59′ that operably engages with the second upright support 52′; more particularly, the second protractor 59′ that operably engages with the outer surface 52D′ of the second upright support 52′. It should be understood that the set of protractors 58′, 59′ are substantially similar to the set of protractors 58, 59 of pivot assembly 12 of drill guide 1 discussed above. As such, first ends 58A′, 59A′, second ends 59A′, 59B′, slots 58C′. 59C′, and set of indicia 58D′, 59D′ of the set of protractors 58′, 59′ are substantially similar to first ends 58A, 59A, second ends 59A, 59B, slots 58C. 59C, and set of indicia 58D, 59D of the set of protractors 58, 59 of pivot assembly 12 described above.

Referring to FIGS. 19 and 20, a set of connectors 60′ operably engages the first and second protractors 58′, 59′ with the first and second upright supports 50′, 52′, which is substantially similar to the set of connectors 60 that operably engages the first and second protractors 58, 59 with the first and second upright supports 50, 52 of pivot assembly 12 of drill guide 1 described above.

Still referring to FIGS. 19 and 20, pivot assembly 12′ also include a set of bearings 62′, 64′ operably engages with the pivot block 54′. It should be understood that the set of bearings 62′, 64′ is substantially similar to the set of bearings 62, 64 of pivot assembly 12 of drill guide 1. A first bearing 62′ is configured to be received by the lower slot 50H′ of the first upright support 50′ when the first bearing 62 operably engages with the pivot block 54′, and a second bearing 64′ is configured to be received by the lower slot 52H′ of the second upright support 52′ when the second bearing 64′ operably engages with the pivot block 54′. During operation, the first and second bearings 62′, 64′ are configured to be slideably moveable relative to the first and second upright supports 50′, 52′ inside of the lower slots 50H′, 52H′ when the pivot block 54′ is pivoted by the woodworker. As such, the first and second bearings 62′, 64′ are configured to guide the pivot block 54′ along the first and second upright supports 50′, 52′ via the lower slots 50H′, 52H′ of the first and second upright supports 50′, 52′.

Referring to FIGS. 19 and 20, pivot assembly 12′ also includes connectors 66′ operably engage the first and second bearings 62′, 64′ with the pivot block 54′. It should be understood that connectors 66′ are substantially similar to the connectors 66 that operably engage the first and second bearings 62, 64 with the pivot block 54 of the pivot assembly 12 of drill guide 1 discussed above.

Drill guide 1′ also includes the calibration assembly 26′. As best seen in FIG. 23, the calibration assembly 26′ includes a base fastener 68A′ and an adjustment fastener 68B′ to collectively calibrate the pivot block 54′ at approximately ninety degrees relative to the base plate 10′. As best seen in FIG. 23, the base fastener 68A′ operably engages with the base plate 10′ via the third threaded vertical passageway 44C′. In one aspect, the base fastener 68A′ threadably engages with the base plate 10′ via the third threaded vertical passageway 44C′. As illustrated, the third threaded vertical passageway 44C′ is countersunk to enable the head of the base fastener 68A′ to be flush and/or even with the top surface 30E′ of the base plate 10′. As best seen in FIG. 23, the adjustment fastener 68B′ operably engages with the pivot block 54′ via the vertical threaded passageway 54N′. In one aspect, the adjustment fastener 68B′ threadably engages with the pivot block 54′ via the vertical threaded passageway 54N′. As described in more detail below, the adjustment fastener 68B′ may be vertically adjustable inside of the pivot block 54′ when a woodworker loosens or tightens the adjustment fastener 68B′ to calibrate the pivot block 54′ with the base plate 10′.

Such combination of the base fastener 68A′ and the adjustment fastener 68B′ is considered advantageous at least because such combination prevents marring or damage to the base plate 10′ when calibrating the pivot block 54′ to the base plate 10′. As illustrated, the adjustment fastener 68B′ only engages and/or interfaces with the base fastener 68A′ when the adjustment fastener 68B′ is adjusted by the woodworker. Stated differently, the adjustment fastener 68B′ is free from engaging the base plate 10′ when calibrating the pivot block 54′ to the base plate 10′. In this operation, the woodworker may simply replace the base fastener 68A′ if the head of the base fastener 68A′ is marred and/or damaged by repeated contact from adjustment fastener 68B′ after repeated calibration operations.

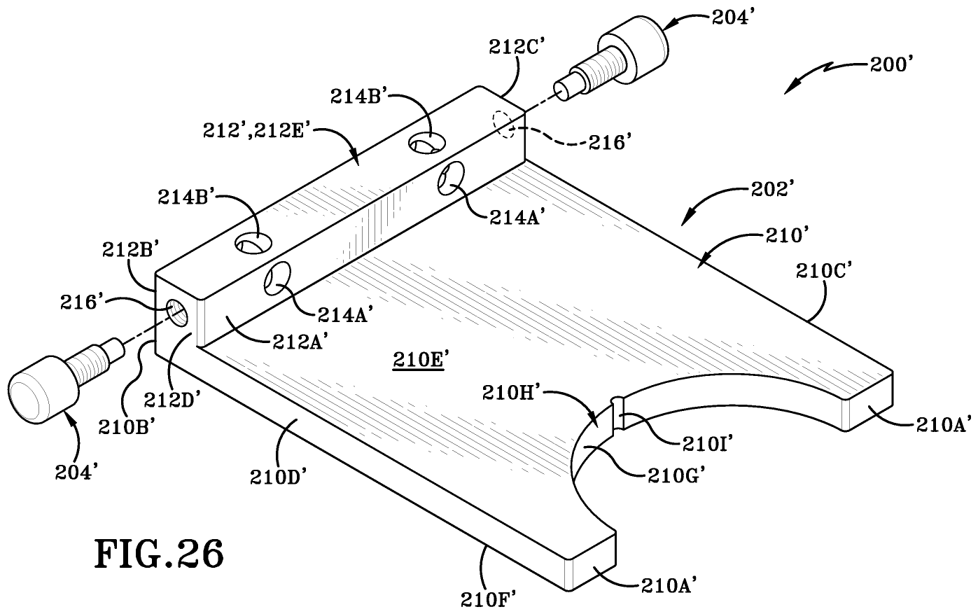

As illustrated in FIGS. 26, the fence assembly 200′ includes a fence 202′, at least one thumb screw 204′ operably engaged with the fence 202′, and at least one guide rod (not illustrated) operably engaged with both the fence 202 and the at least one thumb screw 204. Similar to fence assembly 200 described above, the at least one guide rod of fence assembly 200′ operably engages with base plate 10′ of the drill guide 1′ for operably engaging the fence 202′ with the base plate 10′ for a drilling operation. It should be understood that the fence 202′, the at least one thumb screw 204′, and the at least one guide rod of fence assembly 200′ are substantially similar to the fence 202, the at least one thumb screw 204, and the at least one guide rod 206 of fence assembly 200 described above, except as detailed below. Such use of the fence assembly 200′ with the drill guide 1′ during a drilling operation is described in more detail below.

The fence 202′ includes a plate 210′ and a step 212′ that operably engages with the plate 210′. It should be understood that plate 210′ is substantially similar to plate 210 of fence 202 described above. As such, the plate 210′ includes a front end 210A′, a rear end 210B′, a left side 210C′, a right side 210D′, a first top surface 210E′, and a bottom surface 210F′ substantially similar to front end 210A, rear end 2106, left side 210C, right side 210D, first top surface 210E, and a bottom surface 210F of plate 210 of fence 202 described above. Step 212′ also includes a front end 212A′, a rear end 2126′, a left side 212C′, a right side 212D′, a second top surface 212E′, a first set of passageways 214A′, a second set of passageways 2146′, and a set of threaded passageways 216′ that are substantially similar to front end 212A, rear end 2126, left side 212C, right side 212D, second top surface 212E, first set of passageways 214A, second set of passageways 2146, and set of threaded passageways 216 of step 212 of fence 202 described above.

In this embodiment, however, plate 210′ also includes a curvilinear wall 210G′ that extends into the plate 210′ from the front end 210A′ towards the rear end 2106′. The curvilinear wall 210G′ also defines an aperture 210H′ in the plate 210′ to enable a drill bit to pass through the plate 210′ when the plate 210′ is positioned vertically below the central opening 32′ of the base plate 10′. In one aspect, the aperture 210H′ defined in the plate 210′, via the curvilinear wall 210G′, is configured to enable forstner drill bits defining a diameter up to about 2.5 inches to pass through the plate 210 when the plate 210′ is positioned vertically below the central opening 32′ of the base plate 10′. In another aspect, the aperture 210H′ defined in the plate 210′, via the curvilinear wall 210G′, is configured to enable brad point drill bits defining a diameter of about 2.5 inches to pass through the plate 210 when the plate 210′ is positioned vertically below the central opening 32′ of the base plate 10′.

In this embodiment, plate 210′ may also define at least one indicator 2101′ at the central point of the curvilinear wall 210G′ inside of the aperture 210H′. During drilling operations, a woodworker may reference to the at least one indicator 2101′ for aligning the drill guide 1′ and the fence assembly 200′ with a set of witness marks scribed on a workpiece. In one instance, the woodworker may reference the at least one indicator 2101′ in combination with one or both of the first and second guide markers 38A′, 38B′ for aligning the drill guide 1′ and the fence assembly 200′ with a set of witness marks scribed on a workpiece. In another instance, the woodworker may reference the at least one indicator 2101′ in combination with one or both of the third and fourth guide markers 38C′, 38C′ for aligning the drill guide 1′ and the fence assembly 200′ with a set of witness marks scribed on a workpiece. In yet another instance, the woodworker may reference the at least one indicator 2101′ in combination with one or all of the first, second, third, and fourth guide markers 38A′, 38B′ 38C′, 38D′ for aligning the drill guide 1′ and the fence assembly 200′ with a set of witness marks scribed on a workpiece

Having now described the assemblies and components of drill guide 1′, methods of using the drill guide 1′ to drill at least one hole into a workpiece is described in more detail below.

Prior to using the drill guide 1 for a drilling operation, the woodworker may desire to calibrate the pivot assembly 12′, the pair of guide columns 14′, and the chuck carrier 16′ with the base plate 10′, via the calibration assembly 26′, to ensure the pivot assembly 12′, the pair of guide columns 14′, and the chuck carrier 16′ are positioned approximately ninety degrees relative to the base plate 10′. Stated differently, the woodworker may desire to calibrate the pivot assembly 12′, the pair of guide columns 14′, and the chuck carrier 16′ with the base plate 10′, via the calibration assembly 26′, to ensure the pivot assembly 12′, the pair of guide columns 14′, and the chuck carrier 16′ are positioned orthogonally to the base plate 10′. As best seen in FIG. 23, the woodworker may vertically adjust the adjustment fastener 68B′ inside of the pivot block 54′ until the front end 54A′ of the pivot block 54′ is approximately ninety degrees relative to the base plate 10′ and/or orthogonal to the top surface 30E′ of the base plate 10′. Stated differently, the woodworker may vertically adjust the adjustment fastener 68B′ inside of the pivot block 54′ until the bottom surface 54F′ of the pivot block 54′ is parallel with the top surface 30E′ of the base plate 10′. Such vertical adjustment of the adjustment fastener 68B′ is denoted by a double arrowed labeled “VM” as shown in FIG. 23. Such calibration of the front end 54A′ of the pivot block 54′ relative to the top surface 30E′ of the base plate 10′ is also denoted by double arrows labeled “CO” in FIG. 23 illustrating the orientation of the front end 54A′ of the pivot block 54′ relative to the top surface 30E′ of the base plate 10′.

During the calibration operation, the woodworker may loosen or tighten the adjustment fastener 68B′ relative to the base fastener 68A′. In one instance, the woodworker may adjust the adjustment fastener 68B′ vertically upward away from the base fastener 68A′ by loosening the adjustment fastener 68B′ from the pivot block 54′ when the pivot block 54′ is tilted forwardly towards the front end 30A′ of the base plate 10′. In another instance, the woodworker may adjust the adjustment fastener 68B′ vertically downward towards the base fastener 68A′ by tightening the adjustment fastener 68B′ with the pivot block 54′ when the pivot block 54′ is tilted rearwardly towards the rear end 30B′ of the base plate 10′. In these calibration operations, the adjustment fastener 68B′ engages with the base fastener 68A′ and is free from engaging the base plate 10′ (particularly the top surface 30E′) to prevent marring or damage to the top surface 30E′ of the base plate 10′. While not illustrated herein, a woodworker may remove and replace the original base fastener 68A′ with a new base fastener 68A′ if the original base fastener 68A′ is marred or damage during repeated calibration operations.

Once calibrated, the woodworker may then pivotably adjust the drill guide 1 to a desired drilling angle via the pivot assembly 12′. As best seen in FIG. 25, the woodworker may apply a first rotational movement to the handles 56A′ to loosen the handles 56A′ from threaded shafts 56B′ until the first ends 56A1′ of the handles 56A′ are disengaged from the washers 56D′. Such first rotational movement of the handles 56A′ is denoted by double arrows labeled “R” in FIG. 25. Upon applying the first rotational movement to the handles 56A′, the first ends 56A1′ of the handles 56A′ linearly move away from the washers 56D′ to disengage the first ends 56A1′ from the washers 56D′. Such linear movement of the first ends 56A1′ of handle 56A′ moving away from the washer 56D′ is denoted by an arrow labeled “M1” in FIG. 25. Once the handles 56A′ are disengaged from the washers 56D′, the handles 56A′ are also disengaged from the first and second upright supports 50′, 52′ allowing the woodworker to now pivot the drill guide 1 to the desired angle.

Referring back to FIG. 23, the woodworker may then pivot the drill guide 1′ to the desired drilling angle. Similar to the pivot movement of the drill guide 1 discussed above, the first bearing 62′ and the second bearing 64′ are configured to guide and direct the pivoting movement along the first and second upright supports 50′, 52′. In other words, the first bearing 62′ and the second bearing 64′ are configured to ride along the first and second upright supports 50′, 52′ inside of the lower slots 50H′, 52H′ defined by the first and second upright supports 50′, 52′. Such pivoting movement of the pivot block 54′ along with the guide columns 14′ and the chuck carrier 16′ is denoted by double arrows labeled “PM” in FIG. 23.

Referring back to FIG. 25, the woodworker may then maintain the drill guide 1 at the desired drilling angle by reengaging the handles 56A′ with the first and second upright supports 50′, 52′. As best seen in FIG. 25, the woodworker may apply an opposing second rotational movement to the handles 56A′ to tighten the handles 56A′ with threaded shafts 56B′ until the first ends 56A1′ of the handles 56A′ are reengaged with the washers 56D′ and the first and second upright supports 50′, 52′. Such second rotational movement of the handles 56A′ is also denoted by the double arrows labeled “R” in FIG. 25. Upon applying the second rotational movement to the handles 56A′, the first ends 56A1′ of the handles 56A′ linearly move towards the washers 56D′ to reengage the first ends 56A1′ with the washers 56D′ and the first and second upright supports 50′, 52′. Such linear movement of the first ends 56A1′ of handle 56A′ towards the washer 56D′ is denoted by an arrow labeled “M2” in FIG. 25. Once the handles 56A′ are reengaged from the washers 56D′, the handles 56A′ maintains the drill guide 1′ at the desired drilling angle.

During drilling operations, the woodworker may move button stops 300′ between operating positions and stored positions. In one instance, the woodworker may house a portion of a bench dog 302′ of a first button stop 300A′ inside of the pivot block 54′, via a first passage 54L1′ defined in the pivot block 54′, such that the bench dog 302′ operably engages with the pivot block 54′ in the stored position (as best seen in FIG. 24). Continuing with the same instance, the woodworker may also operably engage a connector 304′ of the first button stop 300A′ with the pivot block 54′, via a first threaded pocket 54M1′, such that the connector 304′ operably engages with the pivot block 54′ in the stored position (as best seen in FIG. 24). In another instance, the woodworker may remove the button stops 300′ from the pivot block 54′ (i.e., stored positions) and operably engage the button stops 300′ with the base plate 10′ (i.e., operating positions) substantially similar to the button stops 300 operably engaged with the base plate 10 discussed above and illustrated in FIGS. 17A-18.

It should be understood that button stops 300′ are substantially similar to button stop 300 discussed above and illustrated in FIGS. 17A-18. As such, the bench dogs 302′ and the connectors 304 are substantially similar to bench dogs 302 and connectors 304 of button stop 300 discussed above.

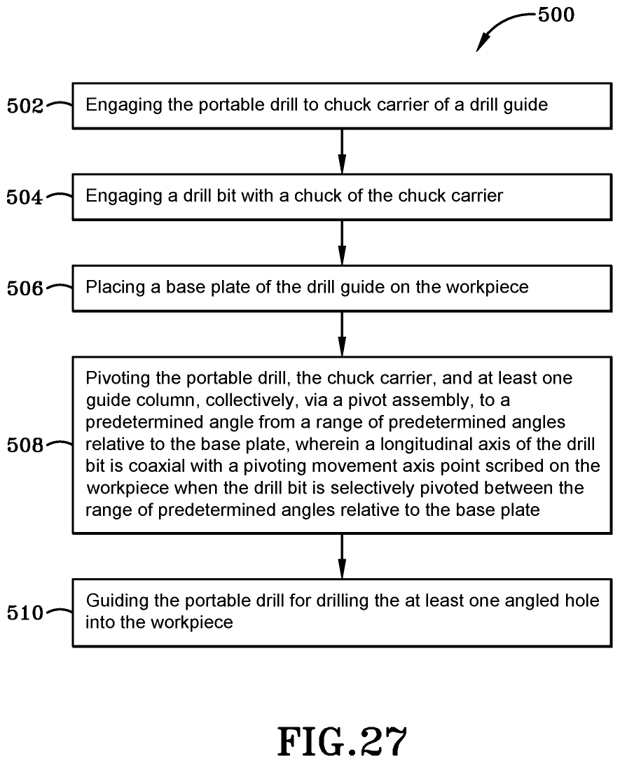

FIG. 27 illustrates a method 500 of guiding a portable drill for drilling at least one angled hole into a workpiece. Initial step 502 of method 500 may include engaging the portable drill to chuck carrier of a drill guide. Another step 504 of method 500 may include engaging a drill bit with a chuck of the chuck carrier. Another step 506 of method 500 may include placing a base plate of the drill guide on the workpiece. Another step 508 of method 500 may include pivoting the portable drill, the chuck carrier, and at least one guide column, collectively, via a pivot assembly, to a predetermined angle from a range of predetermined angles relative to the base plate, wherein a longitudinal axis of the drill bit is coaxial with a pivoting movement axis point scribed on the workpiece when the drill bit is selectively pivoted between the range of predetermined angles relative to the base plate. Another step 510 of method 500 may include guiding the portable drill for drilling the at least one angled hole into the workpiece.

In other exemplary embodiments, method 500 may include additional steps and/or optional steps for guiding a portable drill for drilling at least one angled hole into a workpiece. Optional steps may further include aligning at least one pair of guide markers defined in the base plate with at least one witness line scribed on the workpiece; and aligning at least another pair of guide markers defined in the base plate with at least another witness line scribed on the workpiece; wherein the at least one pair of guide markers are positioned interior to a central opening defined in the base plate; and wherein the at least another pair of guide markers are positioned exterior to the central opening defined in the base plate. Optional steps may further include releasing an adjustment assembly of the pivot assembly from at least one upright support of the pivot assembly; and guiding the adjustment assembly, via an upper slot defined in the at least one upright support, along the at least one upright support. Another optional step may further include guiding at least one bearing, via a lower slot defined in the at least one upright support, along the at least one upright support. Another optional step may further include calibrating the chuck carrier, the at least one guide column, and the pivot assembly, via a calibration assembly, relative to the base plate until the chuck carrier, the at least one guide column, and the pivot assembly are orthogonal to the base plate. Optional steps may further include engaging a first centering button with the base plate; engaging a second centering button with the base plate; engaging the workpiece between the first centering button and the second centering button; and aligning the drill bit in a center of the workpiece via the first centering button and the second centering button; wherein the first centering button and the second centering button are provided in an operating position when engaged with the base plate. Optional steps may further include engaging a first centering button with the base plate; engaging a second centering button with the base plate; engaging the workpiece with the first centering button and the second centering button inside a V-shaped grooved defined in each first centering button and the second centering button, wherein the workpiece is rounded; and aligning the drill bit with an apex of said round workpiece via the first centering button and the second centering button; wherein the first centering button and the second centering button are provided in an operating position when engaged with the base plate. Optional steps may further include engaging a first centering button with a pivot block of the pivot assembly; and engaging a second centering button with the pivot block of the pivot assembly; wherein the first centering button and the second centering button are provided in a stored position when engaged with the pivot block.

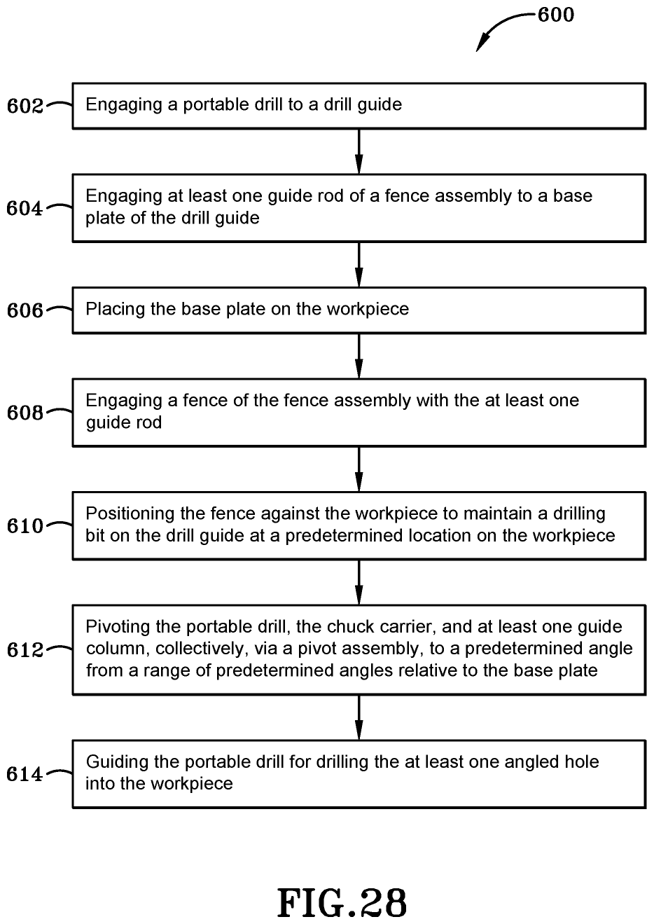

FIG. 28 illustrated another method 600 of guiding a portable drill for drilling at least one angled hole into a workpiece. An initial step 602 of method 600 may include engaging a portable drill to a drill guide. Another step 604 of method 600 may include engaging at least one guide rod of a fence assembly to a base plate of the drill guide. Another step 606 of method 600 may include placing the base plate on the workpiece. Another step 608 of method 600 may include engaging a fence of the fence assembly with the at least one guide rod. Another step 610 of method 600 may include positioning the fence against the workpiece to maintain a drilling bit on the drill guide at a predetermined location on the workpiece. Another step 612 of method 600 may include pivoting the portable drill, the chuck carrier, and at least one guide column, collectively, via a pivot assembly, to a predetermined angle from a range of predetermined angles relative to the base plate. Another step 614 of method 600 may include guiding the portable drill for drilling the at least one angled hole into the workpiece.

In other exemplary embodiments, method 600 may include additional steps and/or optional steps for guiding a portable drill for drilling at least one angled hole into a workpiece. Optional steps may further include scribing a set of witness marks on the workpiece; aligning a set of guide markers of the base plate with the set of witness marks; and aligning an indicator defined on the plate of the fence assembly with at least one witness mark of the set of witness marks; wherein the indicator is aligned with one of the guide markers from the set of guide markers. An optional step may further include that wherein the step of engaging the fence of the fence assembly with the at least one guide rod further includes that a top surface of the plate faces a bottom surface of the base plate; and wherein the method further comprises: positioning a portion of the plate beneath the base plate in which a central opening defined in the base plate and an opening defined in the plate are coaxial with one another. An optional step may further include that the step of engaging the fence of the fence assembly with the at least one guide rod further includes that a top surface of the plate and a top surface of the base plate both face in a same direction. An optional step may further include that the step of engaging the fence of the fence assembly with the at least one guide rod further includes that a top surface of the plate and a top surface of the base plate face in opposite directions. An optional step may further include that the step of engaging the fence of the fence assembly with the at least one guide rod further includes that a bottom surface of the plate is orthogonal to a top surface of the base plate. Optional steps may further include aligning an aperture defined in the plate with a central opening defined in the base plate; and inserting the drilling bit through the base plate, via the central opening, and the plate, via the aperture. Optional steps may further include engaging a first assembly with the base plate that is adapted to retain the base plate in a longitudinal position relative to a first edge of the workpiece; and engaging a second assembly with the base plate that is adapted to retain the base plate in a transverse position relative to a second edge of the workpiece; wherein the first assembly and the second assembly are orthogonal to one another.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A drill guide, comprising:
a base plate adapted to rest on a workpiece;
a pivot assembly selectively moveable with the base plate;
at least one guide column operably engaged with the pivot assembly; and
a chuck carrier operably engaged with the at least one guide column and being linearly moveable relative to the base plate, wherein the chuck carrier is adapted to engage with a portable drill and a drill bit;
wherein the chuck carrier, the at least one guide column, the drill bit, and the portable drill are selectively pivotable with the pivot assembly between a range of predetermined angles relative to the base plate;
wherein the pivot assembly is adapted to enable a longitudinal axis of the drill bit to be coaxial with a predetermined pivoting movement axis point scribed on the workpiece when the drill bit is pivoted at any angle defined in the range of predetermined angles.

2. The drill guide of claim 1, further comprising:
a set of guide markers defined in the base plate enabling the base plate to be directly aligned with a set of witness marks on the workpiece defining the pivoting movement axis point;
wherein the set of guide markers enables the longitudinal axis of the drill bit to be coaxial with the pivoting movement axis point on the workpiece when the drill bit is selectively pivoted between the range of predetermined angles relative to the base plate via the pivot assembly.

3. The drill guide of claim 2, further comprising:
a central opening defined in the base plate and extending entirely through the base plate;
at least one pair of guide markers of the set of guide markers defined in the base plate interior of the central opening; and
at least one another pair of guide markers of the set of guide markers defined in the base plate exterior to the central opening.

4. The drill guide of claim 1, wherein the pivot assembly comprises:
at least one upright support operably engaged with the base plate;
a pivot block operably engaged with the at least one upright support and the at least one guide column; and
at least one adjustment assembly operably engaged with the pivot block;
wherein the at least one adjustment assembly is configured to selectively pivot the chuck carrier, the at least one guide column, and the pivot block relative to the base plate.

5. The drill guide of claim 4, wherein when the at least one adjustment assembly is disengaged from the at least one upright support, the at least one adjustment assembly is configured to selectively pivot the chuck carrier, the at least one guide column, and the pivot block relative to the base plate.

6. The drill guide of claim 4, wherein when the at least one adjustment assembly is engaged with the at least one upright support, the at least one adjustment assembly is configured to maintain the chuck carrier, the at least one guide column, and the pivot block at a desired angle defined in the range of predetermined angles relative to the base plate.

7. The drill guide of claim 4, wherein the at least one adjustment assembly comprises:
a threaded shaft operably engaged with the pivot block; and
a handle operably engaged with the threaded shaft;
wherein the handle is configured to be movable between an engaged position and a disengaged position with the at least one upright support for selectively pivoting the chuck carrier, the at least one guide column, and the pivot block relative to the base plate.

8. The drill guide of claim 7, wherein when the handle is disengaged from the at least one upright support, the at least one adjustment assembly is configured to selectively pivot the chuck carrier, the at least one guide column, and the pivot block relative to the base plate; and
wherein when the handle is engaged with the at least one upright support, the at least one adjustment assembly is configured to maintain the chuck carrier, the at least one guide column, and the pivot block at a desired angle defined in the range of predetermined angles relative to the base plate.

9. The drill guide of claim 7, wherein the at least one adjustment assembly further comprises:
a drag nut operably engaged with the threaded shaft and the at least one upright support and free from engaging the handle;
wherein the drag nut is configured to engage the threaded shaft and the at least one upright support with one another.

10. The drill guide of claim 1, further comprising:
a calibration assembly operably engaged with the base plate and the pivot assembly;
wherein the calibration assembly is configured to collectively calibrate the pivot assembly, the at least one guide column, and the chuck carrier to be orthogonal to the base plate.

11. The drill guide of claim 10, wherein the calibration assembly further comprises:
a base member operably engaged with the base plate; and
an adjustment member operably engaged with a pivot block of the pivot assembly and vertically moveable inside relative to the pivot block;
wherein the adjustment member directly contacts with the base member to collectively calibrate the pivot assembly, the at least one guide column, and the chuck carrier to be orthogonal to the base plate.

12. The drill guide of claim 4, further comprising:
a first centering stop operably engageable with the base plate and the pivot block; and
a second centering stop operably engageable with the base plate and the pivot block;
wherein each of the first centering stop and the second centering stop is operably engaged with the base plate when provided in an operating position for aligning the drill bit in a center of the workpiece;
wherein each of the first centering stop and the second centering stop is operably engaged with pivot block when provided in a stored position.

13. The drill guide of claim 12, further comprising:
a V-shaped groove defined in each of the first centering stop and the second centering stop;
wherein the V-shaped groove defined in each of the first centering stop and the second centering stop enables the first centering stop and the second centering stop to engage with the workpiece and align the drill bit with an apex of the workpiece.

14. A method of guiding a portable drill for drilling at least one angled hole into a workpiece, comprising steps of:
engaging the portable drill to chuck carrier of a drill guide;
engaging a drill bit with a chuck of the chuck carrier;
placing a base plate of the drill guide on the workpiece;
pivoting the portable drill, the chuck carrier, and at least one guide column, collectively, via a pivot assembly, to a predetermined angle from a range of predetermined angles relative to the base plate, wherein a longitudinal axis of the drill bit is coaxial with a pivoting movement axis point scribed on the workpiece when the drill bit is selectively pivoted between the range of predetermined angles relative to the base plate; and
guiding the portable drill for drilling the at least one angled hole into the workpiece.

15. The method of claim 14, further comprising:
aligning at least one pair of guide markers defined in the base plate with at least one witness line scribed on the workpiece; and
aligning at least another pair of guide markers defined in the base plate with at least another witness line scribed on the workpiece;
wherein the at least one pair of guide markers are positioned interior to a central opening defined in the base plate; and
wherein the at least another pair of guide markers are positioned exterior to the central opening defined in the base plate.

16. The method of claim 14, further comprising:
releasing an adjustment assembly of the pivot assembly from at least one upright support of the pivot assembly; and
guiding the adjustment assembly, via an upper slot defined in the at least one upright support, along the at least one upright support.

17. The method of claim 14, further comprising:
guiding at least one bearing, via a lower slot defined in the at least one upright support, along the at least one upright support.

18. The method of claim 14, further comprising:
calibrating the chuck carrier, the at least one guide column, and the pivot assembly, via a calibration assembly, relative to the base plate until the chuck carrier, the at least one guide column, and the pivot assembly are orthogonal to the base plate.

19. The method of claim 14, further comprising:
engaging a first centering button with the base plate;
engaging a second centering button with the base plate;
engaging the workpiece between the first centering button and the second centering button; and
aligning the drill bit in a center of the workpiece via the first centering button and the second centering button;
wherein the first centering button and the second centering button are provided in an operating position when engaged with the base plate.

20. The method of claim 14, further comprising:
engaging a first centering button with the base plate;
engaging a second centering button with the base plate;
engaging the workpiece with the first centering button and the second centering button inside a V-shaped grooved defined in each first centering button and the second centering button, wherein the workpiece is rounded; and
aligning the drill bit with an apex of said round workpiece via the first centering button and the second centering button;
wherein the first centering button and the second centering button are provided in an operating position when engaged with the base plate.

21. The method of claim 14, further comprising:
engaging a first centering button with a pivot block of the pivot assembly; and
engaging a second centering button with the pivot block of the pivot assembly;
wherein the first centering button and the second centering button are provided in a stored position when engaged with the pivot block.
